(19) United States
(12) Patent Application Publication
(10) Pub. No.: US 2015/0264144 A1
(43) Pub. Date: Sep. 17, 2015

(54) HYPER-LOCAL TARGETING BASED ON USER LOCATION

(71) Applicant: DataSphere Technologies, Inc., Bellevue, WA (US)

(72) Inventors: Delane Robert Hewett, Bellevue, WA (US); Christopher Robert Coffman, Seattle, WA (US); Regis Anclades, Redmond, WA (US); Gary Duncan Cowan, Issaquah, WA (US); Satbir Singh Khanuja, Issaquah, WA (US); Peter Howard Brussard, Seattle, WA (US)

(73) Assignee: DataSphere Technologies, Inc., Bellevue, WA (US)

(21) Appl. No.: 14/204,754

(22) Filed: Mar. 11, 2014

(51) Int. Cl. H04L 29/08

(52) U.S. Cl. CPC H04L 67/22

(57) ABSTRACT

Embodiments are directed to managing content over a network. Managed content may be provided to a client application. A widget controller may be arranged to determine locations that may be associated with a consumer based on information included in a consumer profile. The widget controller may enable the consumer to identify a hyper local region corresponding to the determined location that may be associated with the consumer. The widget controller may generate a request for content to a content delivery server based on the consumer's profile. Content corresponding to the request may be provided to the client application from the content delivery server. The widget controller may then deploy to the content to at least one widget. The widget controller may monitor the widgets to detect and track consumer actions with the widgets. The consumer actions may be communicated a content management server for further analysis.

### TECHNICAL FIELD

The present invention relates generally to content management, and more particularly to, generating content that is relevant to consumers and deploying this content onto client applications.

### BACKGROUND

Today, most businesses rely on some form of mobile or internet based promotions to entice customers to purchase its products, access its websites, or visit its physical facility such as a retail store or showroom. These promotions generally include advertisements that inform a consumer about a product and may include coupons, videos, or the like. A large regional or national business can easily afford to research and create customized promotions directed to very large audiences of consumers. However, many small businesses do not have the financial resources to engage in large scale promotions. Also, in many cases, small businesses may be seeking consumers from one or more local regions or neighborhoods. Thus a large area promotion campaign may not be very effective for some small businesses because the campaign may cover a larger geographic region than is advantageous. Also, hosts, such as, website publishers, media outlets, online magazines, or the like, interested in presenting content that promotes small businesses may be unable to customize or configure their digital media properties for effective support of small business promotions. Thus, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a system diagram of an environment in which embodiments of the invention may be implemented;

FIG. 2 shows an embodiment of a client device that may be included in a system such as that shown in FIG. 1;

FIG. 3 shows an embodiment of a network device that may be included in a system such as that shown in FIG. 1;

FIG. 4 illustrates a logical architecture of a system for hyper local targeting based on user locations in accordance with at least one of the various embodiments;

FIG. 5 illustrates and example of hyper local regions in accordance with at least one of the various embodiments

FIG. 6 illustrates a user interface that enables a user to select a local regional of interest in accordance with at least one of the various embodiments;

FIG. 7 is an overview flowchart for a process that provides content to users for providing content to user based on hyper local targeting in accordance with at least one of the various embodiments;

FIG. 8 is a flowchart for a process for determining a user's hyper local region in accordance with at least one of the various embodiments;

FIG. 9 is a flowchart for a process for determining a user's hyper local region in accordance with at least one of the various embodiments;

FIG. 10 is a flowchart for a process for delivering content and loading content into widgets in accordance with at least one of the various embodiments;

FIG. 11 is a flowchart for a process for locating widgets into a client user interface in accordance with at least one of the various embodiments;

FIG. 12 is a flowchart for a process for selecting and/or rotating content that is displayed at a client user interface in accordance with at least one of the various embodiments;

FIG. 13 is a flowchart for a process for providing content for hosts and loading it into a content delivery server in accordance with at least one of the various embodiments;

FIG. 14 is a flowchart for a process for generating content for hosts and loading it into a content delivery server in accordance with at least one of the various embodiments;

FIG. 15 is a flowchart for a process for assigning merchants to hyper local regions in accordance with at least one of the various embodiments;

FIGS. 16A-16D show user-interfaces for hyper local targeting based on user location in accordance with at least one of the various embodiments; and

FIG. 17 shows a user-interface for displaying content that may be illustrative of a coupon for a merchant in accordance with at least one of the various embodiments.

### DETAILED DESCRIPTION OF THE EMBODIMENTS

Various embodiments now will be described more fully hereinafter with reference to the accompanying drawings, which form a part hereof, and which show, by way of illustration, specific embodiments by which the invention may be practiced. The embodiments may, however, be embodied in many different forms and should not be construed as limited to the embodiments set forth herein; rather, these embodiments are provided so that this disclosure will be thorough and complete, and will fully convey the scope of the embodiments to those skilled in the art. Among other things, the various embodiments may be methods, systems, media, or devices. Accordingly, the various embodiments may take the form of an entirely hardware embodiment, an entirely software embodiment, or an embodiment combining software and hardware aspects. The following detailed description is, therefore, not to be taken in a limiting sense.

Throughout the specification and claims, the following terms take the meanings explicitly associated herein, unless the context clearly dictates otherwise. The term “herein” refers to the specification, claims, and drawings associated with the current application. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “widget controller” refers to a computer program that may be operative on a client application. Widget controllers may be downloaded and/or otherwise deployed to a client application. Widget controllers may be arranged to be operative for downloading content, monitoring consumer actions, or otherwise managing widgets located within client applications.

As used herein, the term “widget” refers to a user-interface element located in the client application. Widgets may be invisible or visible to users of the client applications. In some cases, a widget controller may generate widget “on-the-fly” before deploying content into the widget. Widgets may be adapted to reflect the operating environment of the client application that they are being hosted within. For example, in clients that support HTML, CSS a widget may be an HTML element such as a DIV, IFRAME, or the like. For client application operative in a Java environment, a widget may be a View object or Window object, and so on.

As used herein, the terms “hyper-local region,” and “hyper local region” refer to a geographic region (area) that is generally smaller than a metropolitan area. A common characteristic of hyper-local regions may be that they are not readily discernible using standard location techniques, such as, Internet Protocol (IP) Addresses, Postal codes, or the like. For example, hyper-local regions may be neighborhoods in cities that may represent regions that may or may not be recognized by an official government body. Also, one or more neighborhoods may be associated with a single hyper-local region. Neighborhoods may be classified using a hierarchy into larger neighborhoods, townships, or cities. These relationships may be useful for managing selection or determination of what might otherwise be very large lists of small neighborhoods or hyper-local regions. In at least one of the various embodiments, merchants or consumers may be associated with one or more hyper-local regions.

As used herein, the terms “customer,” or “merchant” may refer to an individual person, partnership, organization, corporate entity, or the like that operates as a separately identifiable business that contracts with a hyper local targeting system. In at least one of the various embodiments, the customer may contract to have content generated and/or display on one or more Host digital media properties (e.g., websites, mobile applications, or the like). The customer may sell or provide a product to consumers through a website or at a physical facility such as a retail store, showroom, warehouse, office, restaurant, and the like. In at least one of various embodiments, a customer may also be referred to as a retailer, vendor, professional, products provider, user of the content management application, or the like.

As used herein, the term “Host” may refer to an individual person, partnership, organization, or corporate entity that may own or operate one or more digital media properties (e.g., web sites, mobile applications, or the like). Hosts may arrange digital media properties to use hyper-local targeting by arranging the property to integrate with widget controllers, content management servers, or content delivery servers.

As used herein, the term “consumer” may refer to an individual person, partnership, organization, or corporate entity that may purchase, license, lease, or otherwise obtain one or more products from a customer or merchant, where the consumer and the customer are different and separately identifiable. Consumers are those entities that visit the client applications associated with a Host's digital media properties. The content management servers and/or content delivery servers may enable consumers to view and/or interact with content presented on one or most Host digital media properties.

As used herein, the term “offering” may refer to a product, good and/or service that a customer or merchant offers and/or otherwise may make available to consumers.

As used herein, the term “coupon” may refer to a type of content that entitles the holder (e.g., a consumer) of the coupon to redeem a discount on and/or obtain a free product offered by a merchant. In some embodiments, a coupon may be related to a particular product and/or a type of product offered by the merchant. For example, coupons may include, but are not limited to, “Buy 1 Get 1 Free,” “Free Beverage with $5 purchase,” “Free 1 hour consultation,” “$20 off purchase,” “30% off a $100 purchase,” or the like. In at least one embodiment, products that are relatively less expensive, such as food, may be associated with a coupon that offers the product for free. Also, other products that are relatively more expensive, such as professional services, may be associated with coupons that offer the product at a discount.

As used herein, the term “content” may refer to any information and/or data that can be provided to a consumer including textual, graphical, and/or audio content, as well as computer programs. Content may include online content, videos, images, animation, graphics, illustrations, audio files, text, text messages, emails, documents, posters, flyers, letters, or the like which can be used in product promotions for advertisements, product information, customer information, coupons, or the like. Also, in at least one of the various embodiments, content may also include computer programs, source code, executables, scripts, or the like, or combination thereof.

As used herein, the term “category” may refer to a classification of a customer and/or content. Example categories include, but are not limited to “Health and Beauty,” “Automotive,” “Travel,” or the like. Categories may also be referred to in some embodiments as business categories. Also, in at least one of the various embodiments, consumers, customers, merchants, and content may be classified into one or more categories.

As used herein, the terms “actions” and/or “monitored actions” may refer to a behavior or act being performed on and/or with content, including content displayed in a widget. Actions may include online and/or offline behaviors, such as clicking on content, redeeming a coupon, or the like. In some embodiments, actions may be performed by a consumer on published content (e.g., videos, banners, coupons, or the like). These actions may include, but are not limited to searching, viewing, mousing over, scrolling, selecting, reading, clicking on, printing, sharing, redeeming, or the like. In other embodiments, actions may be performed by a customer on content, such as, but not limited to, modifying a content template and/or other content provided in an advertisement template.

The following briefly describes embodiments of the invention in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated, various embodiments are directed to managing content over a network. In at least one of the various embodiments, managed content may be provided to a client application, such as a web browser or mobile application, or the like. In at least one of the various embodiments, a widget controller that is arranged to enable additional actions discussed below may be provided to the client application and/or client device.

In at least one of the various embodiments, the widget controller may be arranged to determine at least one location that may be associated with a consumer visiting the client application based on information included in a profile of the consumer. The widget controller may enable the consumer to identify a hyper local region that corresponds to the determined location (e.g., neighborhoods within a city) that may be associated with the consumer by updating the consumer profile with the identified hyper local regions. In at least one of the various embodiments, the widget controller may generate a request for content to at least one content delivery server based on the consumer's updated profile. In response the request, content corresponding to the request may be provided to the client application from the at least one content delivery server. In at least one of the various embodiments, the widget controller may then deploying to the content to at least one widget based on the type content.

In at least one of the various embodiments, the widget controller may continue to monitor the widgets to detect and track consumer actions and/or interactions with the widgets. In at least one of the various embodiments, the consumer actions and/or interactions may be communicated to a content management server for further analysis.

In at least one of the various embodiments, if a visit count associated with the consumer exceeds a defined threshold, the widget controller and/or the client application may be arranged to prompt the consumer to identify a hyper-local region that the consumer may be interested in. If the consumer selects a hyper local region, the consumer profile for this consumer may be modified to include the identified hyper-local region.

In at least one of the various embodiments, the content that is provided to the client application, may includes advertisements, coupons, news stories/article, events, or the like that may be associated with the hyper-local region that is associated with the consumer who is visiting the client application.

In at least one of the various embodiments, the widget controller, a content delivery server, and a content management server may generate a plurality of metrics based on the monitoring of consumer actions. One or more of these metrics may be analyzed to infer a hyper-local region that may be associated with the consumer. Accordingly, in at least one of the various embodiments, the consumer profile may be modified to include the determined hyper-local region.

In at least one of the various embodiments, to avoid causing the loading and/or performance delays when a client application is visited by the consumer, the widget controller may register an event (such as a timer) with the client application. After the event is registered, in at least one of the various embodiments, the widget controller may suspend itself and yield control to the client application. In at least one of the various embodiments, suspending the widget controller enables the client application to process other client content separate and independent from the content being processed and/or downloaded by the widget controller. Responsive to the event firing, the widget controller may be restored to operation and continue processing and/or downloading content.

In at least one of the various embodiments, the widget controller may determine one or more locations in the client application for displaying each widget and/or the content that may be associated with a widget. Unless the display location accommodates the widgets, the widget controller may modify at least one geometric attribute of a non-accommodated widget to fit the display location (e.g., scaling the images). Also, in at least one of the various embodiments, if two or more widgets include content that may be similarly classified, the widget controller may rotate the content to avoid displaying similarly classified content at the same time on the on the same client application.

In at least one of the various embodiments, the content provided to the client may include at least one of an advertisement, a coupon, a news story, or an event that is associated with the at least one identified hyper-local region.

In at least one of the various embodiments, a content management server may be employed to classifying merchants based on an offering of services and/or products. Also, in at least one of the various embodiments, the content management server may determine at least one candidate hyper-local region based on a geographic location that is associated the merchants. If the number of other merchants having the same classification is less than a defined threshold value, the merchant may be associated with the candidate hyper-local region.

### Illustrative Operating Environment

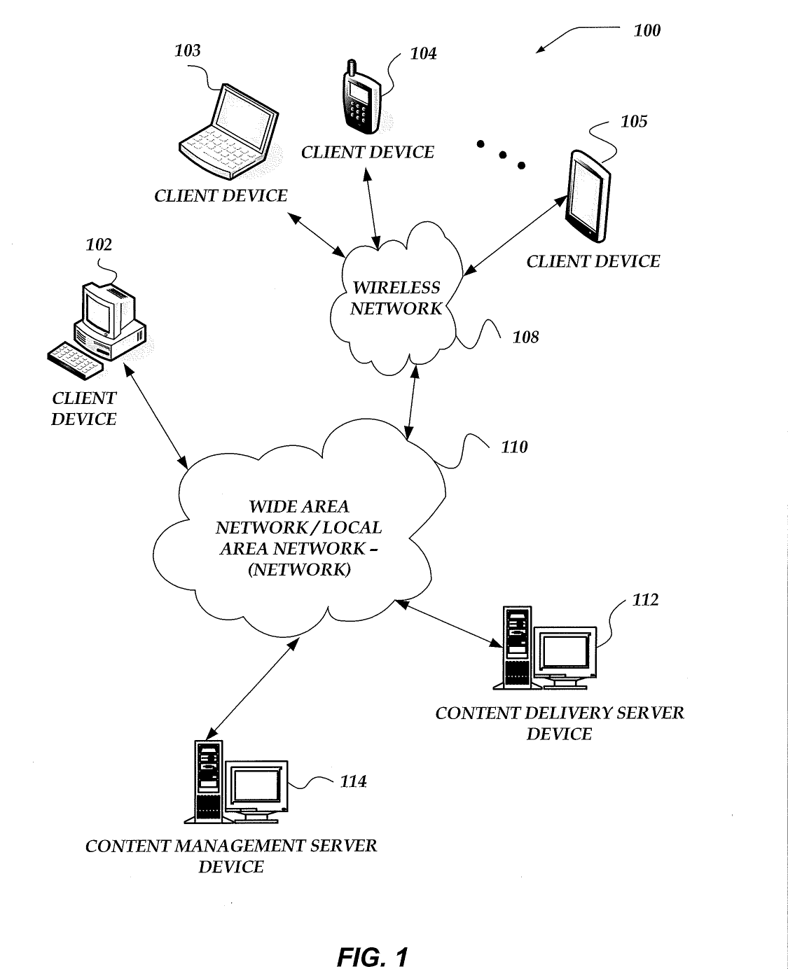

FIG. 1 shows components of one embodiment of an environment in which embodiments of the innovations described herein may be practiced. Not all of the components may be required to practice the innovations, and variations in the arrangement and type of the components may be made without departing from the spirit or scope of the innovations. As shown, system 100 of FIG. 1 includes local area networks (LANs)/wide area networks (WANs)-(network) 110, wireless network 108, client devices 102-105, Content Delivery Server Device (CDSD) 112, and Content Management Server Device (CMSD) 114.

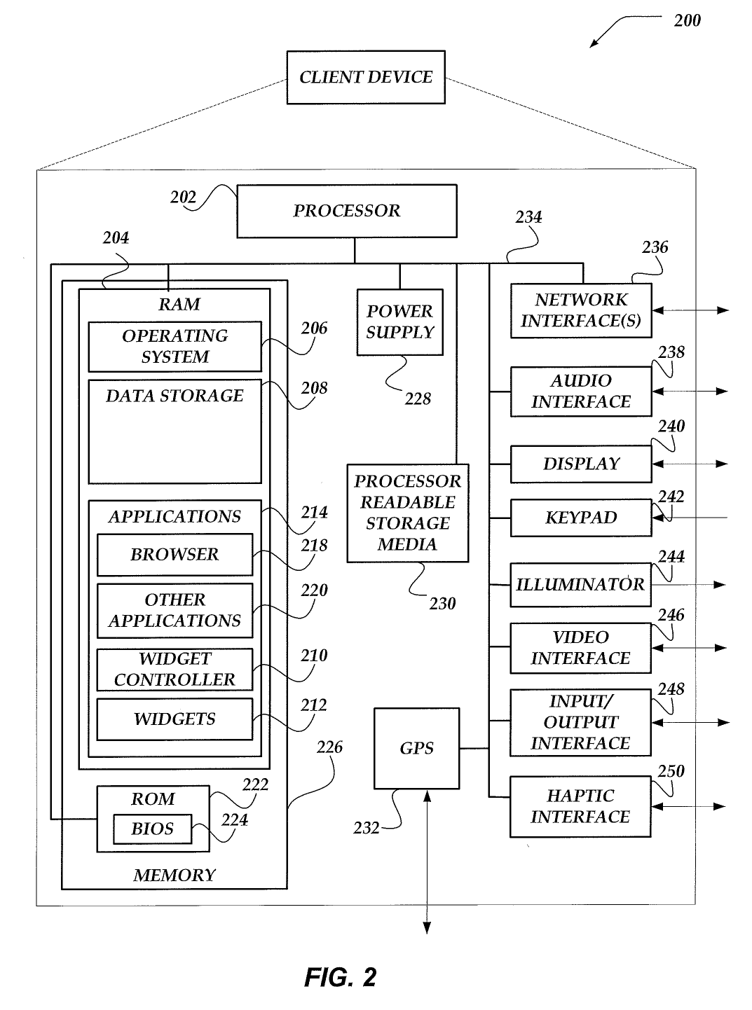

At least one embodiment of client devices 102-105 is described in more detail below in conjunction with FIG. 2. In one embodiment, at least some of client devices 102-105 may operate over a wired and/or wireless network, such as networks 110 and/or 108. Generally, client devices 102-105 may include virtually any computing device capable of communicating over a network to send and receive information, perform various online activities, offline actions, or the like. In one embodiment, one or more of client devices 102-105 may be configured to operate within a business or other entity to perform a variety of services for the business or other entity. For example, client devices 102-105 may be configured to operate as a web server, an accounting server, a production server, an inventory server, or the like. However, client devices 102-105 are not constrained to these services and may also be employed, for example, as an end-user computing node, in other embodiments. It should be recognized that more or less client devices may be included within a system such as described herein, and embodiments are therefore not constrained by the number or type of client devices employed.

Devices that may operate as client device 102 may include devices that typically connect using a wired or wireless communications medium such as personal computers, multiprocessor systems, microprocessor-based or programmable electronic devices, network PCs, or the like. In some embodiments, client devices 102-105 may include virtually any portable personal computing device capable of connecting to another computing device and receiving information such as, laptop computer 103, smart mobile telephone 104, and tablet computers 105, and the like. However, portable computing devices are not so limited and may also include other portable devices such as cellular telephones, display pagers, radio frequency (RF) devices, infrared (IR) devices, Personal Digital Assistants (PDAs), handheld computers, wearable computers, integrated devices combining one or more of the preceding devices, and the like. As such, client devices 102-105 typically range widely in terms of capabilities and features. Moreover, client devices 102-105 may access various computing applications, including a browser, or other web-based application.

A web-enabled client device may include a browser application that is configured to receive and to send web pages, web-based messages, and the like. The browser application may be configured to receive and display graphics, text, multimedia, and the like, employing virtually any web-based language, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), and the like, to display and send a message. In one embodiment, a user of the client device may employ the browser application to perform various activities over a network (online). However, another application may also be used to perform various online activities.

Client devices 102-105 may also include at least one other client application that is configured to receive and/or send content between another computing device. The client application may include a capability to send and/or receive content, or the like. The client application may further provide information that identifies itself, including a type, capability, name, and the like. In one embodiment, client devices 102-105 may uniquely identify themselves through any of a variety of mechanisms, including an Internet Protocol (IP) address, a phone number, Mobile Identification Number (MIN), an electronic serial number (ESN), or other device identifier. Such information may be provided in a network packet, or the like, sent between other client devices, Content Delivery Server Device 112, Content Management Server Device 114, or other computing devices.

Client devices 102-105 may further be configured to include a client application that enables an end-user to log into an end-user account that may be managed by another computing device, such as Content Delivery Server Device 112, Content Management Server Device 114, or the like. Such end-user account, in one non-limiting example, may be configured to enable the end-user to manage one or more online activities, including in one non-limiting example, search activities, social networking activities, browse various websites, communicate with other users, or the like. However, participation in such online activities may also be performed without logging into the end-user account.

Wireless network 108 is configured to couple client devices 103-105 and its components with network 110. Wireless network 108 may include any of a variety of wireless sub-networks that may further overlay stand-alone ad-hoc networks, and the like, to provide an infrastructure-oriented connection for client devices 103-105. Such sub-networks may include mesh networks, Wireless LAN (WLAN) networks, cellular networks, and the like. In one embodiment, the system may include more than one wireless network.

Wireless network 108 may further include an autonomous system of terminals, gateways, routers, and the like connected by wireless radio links, and the like. These connectors may be configured to move freely and randomly and organize themselves arbitrarily, such that the topology of wireless network 108 may change rapidly.

Wireless network 108 may further employ a plurality of access technologies including 2nd (2G), 3rd (3G), 4th (4G) 5th (5G) generation radio access for cellular systems, WLAN, Wireless Router (WR) mesh, and the like. Access technologies such as 2G, 3G, 4G, 5G, and future access networks may enable wide area coverage for mobile devices, such as client devices 103-105 with various degrees of mobility. In one non-limiting example, wireless network 108 may enable a radio connection through a radio network access such as Global System for Mobil communication (GSM), General Packet Radio Services (GPRS), Enhanced Data GSM Environment (EDGE), code division multiple access (CDMA), time division multiple access (TDMA), Wideband Code Division Multiple Access (WCDMA), High Speed Downlink Packet Access (HSDPA), Long Term Evolution (LTE), and the like. In essence, wireless network 108 may include virtually any wireless communication mechanism by which information may travel between client devices 103-105 and another computing device, network, and the like.

Network 110 is configured to couple network devices with other computing devices, including, Content Delivery Server Device 112, Content Management Server Device 114, client device 102, and client devices 103-105 through wireless network 108. Network 110 is enabled to employ any form of computer readable media for communicating information from one electronic device to another. Also, network 110 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, and/or other carrier mechanisms including, for example, E-carriers, Integrated Services Digital Networks (ISDNs), Digital Subscriber Lines (DSLs), wireless links including satellite links, or other communications links known to those skilled in the art. Moreover, communication links may further employ any of a variety of digital signaling technologies, including without limit, for example, DS-0, DS-1, DS-2, DS-3, DS-4, OC-3, OC-12, OC-48, or the like. Furthermore, remote computers and other related electronic devices could be remotely connected to either LANs or WANs via a modem and temporary telephone link. In one embodiment, network 110 may be configured to transport information of an Internet Protocol (IP). In essence, network 110 includes any communication method by which information may travel between computing devices.

Additionally, communication media typically embodies computer readable instructions, data structures, program modules, or other transport mechanism and includes any information delivery media. By way of example, communication media includes wired media such as twisted pair, coaxial cable, fiber optics, wave guides, and other wired media and wireless media such as acoustic, RF, infrared, and other wireless media.

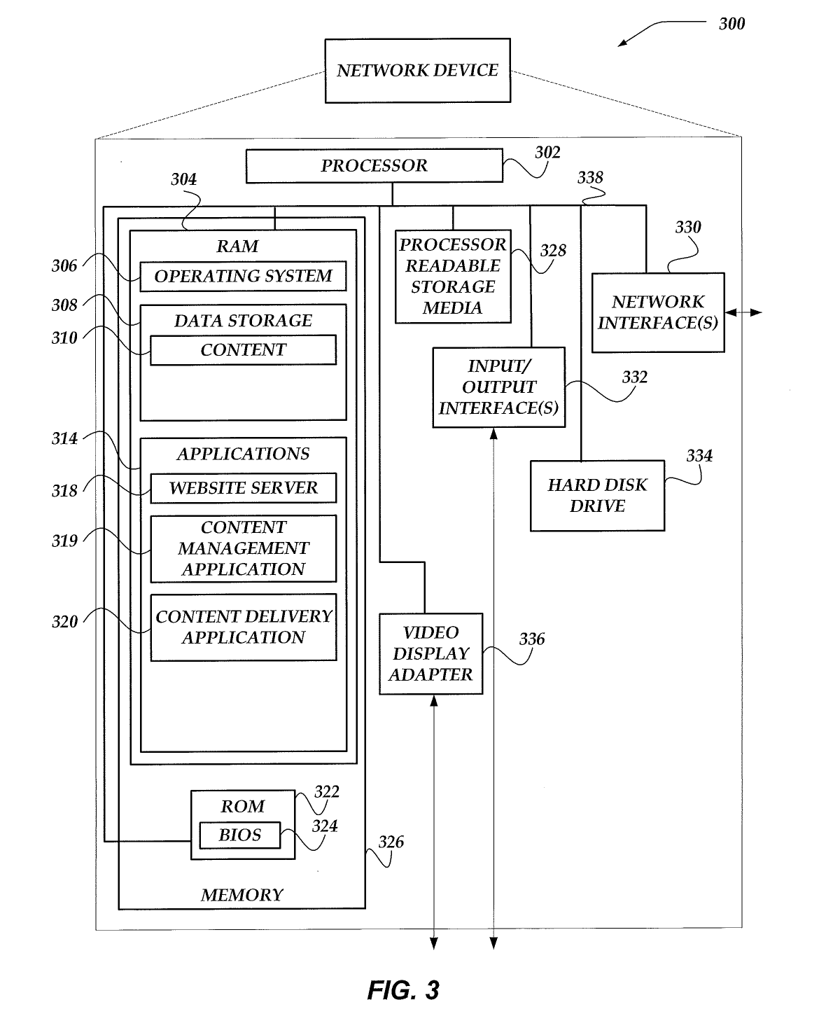

One embodiment of Content Delivery Server Device 112 is described in more detail below in conjunction with FIG. 3. Briefly, however, Content Delivery Server Device 112 includes virtually any network device capable of ranking a plurality of coupons and/or coupon templates for each of a plurality of different categories and recommending a subset of a plurality of coupon templates to a customer. In at least one embodiment, Content Delivery Server Device 112 may determine which coupons to recommend to a customer based on a plurality of factors, including, but not limited to, a ranked order of the plurality of coupon templates, a category of the customer, one or more external variables (e.g., a reputation of the customer, a location of the customer, or a dollar amount associated with a coupon), or the like. In some embodiments, Content Delivery Server Device 112 may enable a client's devices to download widget controllers and widgets for display of static and/or interactive content, such as, video, audio, news, events, coupons, advertising, or the like, or combination thereof. Devices that may be arranged to operate as Content Delivery Server Device 112 include various network devices, including, but not limited to personal computers, desktop computers, multiprocessor systems, microprocessor-based or programmable consumer electronics, network PCs, server devices, network appliances, and the like.

Although FIG. 1 illustrates Content Delivery Server Device 112 as a single computing device, the invention is not so limited. For example, one or more functions of the Content Delivery Server Device 112 may be distributed across one or more distinct network devices. Moreover, Content Delivery Server Device 112 is not limited to a particular configuration. Thus, in one embodiment, Content Delivery Server Device 112 may contain a plurality of network devices. In another embodiment, Content Delivery Server Device 112 may contain a plurality of network devices that operate using a master/slave approach, where one of the plurality of network devices of Content Delivery Server Device 112 is operative to manage and/or otherwise coordinate operations of the other network devices. In other embodiments, the Content Delivery Server Device 112 may operate as a plurality of network devices arranged in a cluster architecture, a peer-to-peer architecture, and/or even within a cloud architecture. Thus, the invention is not to be construed as being limited to a single environment, and other configurations, and architectures are also envisaged.

One embodiment of Content Management Server Device 114 is described in more detail below in conjunction with FIG. 3. Briefly, however, Content Management Server Device 114 includes virtually any network device capable of monitoring actions associated with published coupons. In some embodiments, the coupons may be published by Content Delivery Server Device 112, Content Management Server Device 114, or another network device (e.g., a web server) (not shown). Content Management Server Device 114 may determine statistics regarding the published content. Further, in at least one of the various embodiments, Content Management Server Device 114 may deliver content, including widget controllers, widgets, audio, video, images, html, news, events, or the like, or combination thereof, to Content Delivery Server Device 112 for subsequent delivery to clients. Devices that may be arranged to operate as Content Management Server Device 114 include various network devices, including, but not limited to personal computers, desktop computers, multiprocessor systems, microprocessor-based or programmable consumer electronics, network PCs, server devices, network appliances, and the like.

Although FIG. 1 illustrates Content Management Server Device 114 as a single computing device, the various embodiments are not so limited. For example, one or more functions of the Content Management Server Device 114 may be distributed across one or more distinct network devices. Moreover, Content Management Server Device 114 is not limited to a particular configuration. Thus, in one embodiment, Content Management Server Device 114 may contain a plurality of network devices. In another embodiment, Content Management Server Device 114 may contain a plurality of network devices that operate using a master/slave approach, where one of the plurality of network devices of Content Management Server Device 114 operates to manage and/or otherwise coordinate operations of the other network devices. In other embodiments, the Content Management Server Device 114 may operate as a plurality of network devices within a cluster architecture, a peer-to-peer architecture, and/or even within a cloud architecture. Thus, the invention is not to be construed as being limited to a single environment, and other configurations, and architectures are also envisaged.

Although illustrated separately, Content Delivery Server Device 112 and Content Management Server Device 114 may be employed as a single network device, separate network devices, a cluster of network devices, or the like. In some embodiments, either Content Delivery Server Device 112 or Content Management Server Device 114, or both, may be enabled to deliver content, respond to user interactions with the content, track user interaction with the content, update widgets and widgets controllers, or the like.

### Illustrative Client Device

FIG. 2 shows one embodiment of client device 200 that may be included in a system implementing embodiments of the invention. Client device 200 may include many more or less components than those shown in FIG. 2. However, the components shown are sufficient to disclose an illustrative embodiment for practicing the present invention. Client device 200 may represent, for example, one embodiment of at least one of client devices 102-105 of FIG. 1.

As shown in the figure, client device 200 includes a processor 202 in communication with a mass memory 226 via a bus 234. In some embodiments, processor 202 may include one or more central processing units (CPU). Client device 200 also includes a power supply 228, one or more network interfaces 236, an audio interface 238, a display 240, a keypad 242, an illuminator 244, a video interface 246, an input/output interface 248, a haptic interface 250, and a global positioning system (GPS) receiver 232.

Power supply 228 provides power to client device 200. A rechargeable or non-rechargeable battery may be used to provide power. The power may also be provided by an external power source, such as an alternating current (AC) adapter or a powered docking cradle that supplements and/or recharges a battery.

Client device 200 may optionally communicate with a base station (not shown), or directly with another computing device. Network interface 236 includes circuitry for coupling client device 200 to one or more networks, and is constructed for use with one or more communication protocols and technologies including, but not limited to, GSM, CDMA, TDMA, GPRS, EDGE, WCDMA, HSDPA, LTE, user datagram protocol (UDP), transmission control protocol/Internet protocol (TCP/IP), short message service (SMS), WAP, ultra wide band (UWB), IEEE 802.16 Worldwide Interoperability for Microwave Access (WiMax), session initiated protocol/real-time transport protocol (SIP/RTP), or any of a variety of other wireless communication protocols. Network interface 236 is sometimes known as a transceiver, transceiving device, or network interface card (NIC).

Audio interface 238 is arranged to produce and receive audio signals such as the sound of a human voice. For example, audio interface 238 may be coupled to a speaker and microphone (not shown) to enable telecommunication with others and/or generate an audio acknowledgement for some action.

Display 240 may be a liquid crystal display (LCD), gas plasma, light emitting diode (LED), organic LED, or any other type of display used with a computing device. Display 240 may also include a touch sensitive screen arranged to receive input from an object such as a stylus or a digit from a human hand.

Keypad 242 may comprise any input device arranged to receive input from a user. For example, keypad 242 may include a push button numeric dial, or a keyboard. Keypad 242 may also include command buttons that are associated with selecting and sending images.

Illuminator 244 may provide a status indication and/or provide light. Illuminator 244 may remain active for specific periods of time or in response to events. For example, when illuminator 244 is active, it may backlight the buttons on keypad 242 and stay on while the client device is powered. Also, illuminator 244 may backlight these buttons in various patterns when particular actions are performed, such as dialing another client device. Illuminator 244 may also cause light sources positioned within a transparent or translucent case of the client device to illuminate in response to actions.

Video interface 246 is arranged to capture video images, such as a still photo, a video segment, an infrared video, or the like. For example, video interface 246 may be coupled to a digital video camera, a web-camera, or the like. Video interface 246 may comprise a lens, an image sensor, and other electronics. Image sensors may include a complementary metal-oxide-semiconductor (CMOS) integrated circuit, charge-coupled device (CCD), or any other integrated circuit for sensing light.

Client device 200 also comprises input/output interface 248 for communicating with external devices, such as a headset, or other input or output devices not shown in FIG. 2. Input/output interface 248 can utilize one or more communication technologies, such as USB, infrared, Bluetooth™, or the like.

Haptic interface 250 is arranged to provide tactile feedback to a user of the client device. For example, the haptic interface 250 may be employed to vibrate client device 200 in a particular way when another user of a computing device is calling. In some embodiments, haptic interface 250 may be optional.

Client device 200 may also include GPS transceiver 232 to determine the physical coordinates of client device 200 on the surface of the Earth. GPS transceiver 232, in some embodiments, may be optional. GPS transceiver 232 typically outputs a location as latitude and longitude values. However, GPS transceiver 232 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of client device 200 on the surface of the Earth. It is understood that under different conditions, GPS transceiver 232 can determine a physical location within millimeters for client device 200; and in other cases, the determined physical location may be less precise, such as within a meter or significantly greater distances. In one embodiment, however, mobile device 200 may through other components, provide other information that may be employed to determine a physical location of the device, including for example, a Media Access Control (MAC) address, IP address, or the like.

Mass memory 226 includes a Random Access Memory (RAM) 204, a Read-only Memory (ROM) 222, and other storage means. Mass memory 226 illustrates an example of computer readable storage media (devices) for storage of information such as computer readable instructions, data structures, program modules or other data. Mass memory 226 stores a basic input/output system (BIOS) 224 for controlling low-level operation of client device 200. The mass memory also stores an operating system 206 for controlling the operation of client device 200. It will be appreciated that this component may include a general-purpose operating system such as a version of UNIX, or LINUX™, or a specialized client communication operating system such as Microsoft Corporation's Windows Mobile™, Apple Corporation's iOS™, Google Corporation's Android™ or the Symbian® operating system. The operating system may include, or interface with a Java virtual machine module that enables control of hardware components and/or operating system operations via Java application programs.

Mass memory 226 further includes one or more data storage 208, which can be utilized by client device 200 to store, among other things, applications 214 and/or other data. For example, data storage 208 may also be employed to store information that describes various capabilities of client device 200. The information may then be provided to another device based on any of a variety of events, including being sent as part of a header during a communication, sent upon request, or the like. Data storage 208 may also be employed to store social networking information including address books, buddy lists, aliases, user profile information, or the like. Further, data storage 208 may also store message, we page content, or any of a variety of user generated content. At least a portion of the information may also be stored on another component of network device 200, including, but not limited to processor readable storage media 230, a disk drive or other computer readable storage devices (not shown) within client device 200.

Processor readable storage media 230 may include volatile, nonvolatile, removable, and non-removable media implemented in any method or technology for storage of information, such as computer- or processor-readable instructions, data structures, program modules, or other data. Examples of computer readable storage media include RAM, ROM, Electrically Erasable Programmable Read-only Memory (EEPROM), flash memory or other memory technology, Compact Disc Read-only Memory (CD-ROM), digital versatile disks (DVD) or other optical storage, magnetic cassettes, magnetic tape, magnetic disk storage or other magnetic storage devices, or any other physical medium which can be used to store the desired information and which can be accessed by a computing device. Processor readable storage media 230 may also be referred to herein as computer readable storage media and/or computer readable storage device.

Applications 214 may include computer executable instructions which, when executed by client device 200, transmit, receive, and/or otherwise process network data. Network data may include, but is not limited to, messages (e.g. SMS, Multimedia Message Service (MMS), instant message (IM), email, and/or other messages), audio, video, and enable telecommunication with another user of another client device. Applications 214 may include, for example, browser 218, and other applications 220. Other applications 220 may include, but are not limited to, calendars, search programs, email clients, IM applications, SMS applications, voice over Internet Protocol (VOIP) applications, contact managers, task managers, transcoders, database programs, word processing programs, security applications, spreadsheet programs, games, search programs, and so forth.

Browser 218 may include virtually any application configured to receive and display graphics, text, multimedia, messages, and the like, employing virtually any web based language. In one embodiment, the browser application is enabled to employ HDML, WML, WMLScript, JavaScript, SGML, HTML, XML, and the like, to display and send a message. However, any of a variety of other web-based programming languages may be employed. In one embodiment, browser 218 may enable a user of client device 200 to communicate with another network device, such as Content Delivery Server Device 112 and/or Content Management Server Device 114 of FIG. 1.

Applications 214 may also include Widget Controller 210 and one or more Widgets 212. Widgets 212 may be collections of content provided to the client device by Content Delivery Service Device 112. Widget Controller 210 may be a program that may be provided to the client device by Content Delivery Server Device 113. Widget Controller 210 and Widgets 212 may run as native client device applications or they may run in Browser 218 as web browser based applications. Also, Widget Controller 210 and Widgets 212 may be arranged to run as native applications or web browser applications, or combination thereof.

### Illustrative Network Device

FIG. 3 shows one embodiment of a network device 300, according to one embodiment of the invention. Network device 300 may include many more or less components than those shown. The components shown, however, are sufficient to disclose an illustrative embodiment for practicing the invention. Network device 300 may be configured to operate as a server, client, peer, a host, or any other device. Network device 300 may represent, for example Content Delivery Server Device 112 and/or Content Management Server Device 114 of FIG. 1, and/or other network devices.

Network device 300 includes processor 302, processor readable storage media 328, network interface unit 330, an input/output interface 332, hard disk drive 334, video display adapter 336, and memory 326, all in communication with each other via bus 338. In some embodiments, processor 302 may include one or more central processing units.

As illustrated in FIG. 3, network device 300 also can communicate with the Internet, or some other communications network, via network interface unit 330, which is constructed for use with various communication protocols including the TCP/IP protocol. Network interface unit 330 is sometimes known as a transceiver, transceiving device, or network interface card (NIC).

Network device 300 also comprises input/output interface 332 for communicating with external devices, such as a keyboard, or other input or output devices not shown in FIG. 3. Input/output interface 332 can utilize one or more communication technologies, such as USB, infrared, Bluetooth™, or the like.

Memory 326 generally includes RAM 304, ROM 322 and one or more permanent mass storage devices, such as hard disk drive 334, tape drive, optical drive, and/or floppy disk drive. Memory 326 stores operating system 306 for controlling the operation of network device 300. Any general-purpose operating system may be employed. Basic input/output system (BIOS) 324 is also provided for controlling the low-level operation of network device 300.

Although illustrated separately, memory 326 may include processor readable storage media 328. Processor readable storage media 328 may be referred to and/or include computer readable media, computer readable storage media, and/or processor readable storage device. Processor readable storage media 328 may include volatile, nonvolatile, removable, and non-removable media implemented in any method or technology for storage of information, such as computer readable instructions, data structures, program modules, or other data. Examples of processor readable storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other media which can be used to store the desired information and which can be accessed by a computing device.

Memory 326 further includes one or more data storage 308, which can be utilized by network device 300 to store, among other things, applications 314 and/or other data such as content 310. For example, data storage 308 may also be employed to store information that describes various capabilities of network device 300. The information may then be provided to another device based on any of a variety of events, including being sent as part of a header during a communication, sent upon request, or the like. Data storage 308 may also be employed to store messages, web page content, or the like. At least a portion of the information may also be stored on another component of network device 300, including, but not limited to processor readable storage media 328, hard disk drive 334, or other computer readable storage medias (not shown) within client device 300

Data storage 308 may include a database, text, spreadsheet, folder, file, or the like, that may be configured to maintain and store user account identifiers, user profiles, email addresses, IM addresses, and/or other network addresses; or the like. Data storage 308 may further include program code, data, algorithms, and the like, for use by a processor, such as processor 302 to execute and perform actions. In one embodiment, at least some of data store 308 might also be stored on another component of network device 300, including, but not limited to processor-readable storage media 328, hard disk drive 334, or the like.

Applications 314 may include computer executable instructions, which may be loaded into mass memory and run on operating system 306. Examples of application programs may include transcoders, schedulers, calendars, database programs, word processing programs, Hypertext Transfer Protocol (HTTP) programs, customizable user interface programs, IPSec applications, encryption programs, security programs, SMS message servers, IM message servers, email servers, account managers, and so forth. Applications 314 may also include website server 318, Content Management Application 319, and Content Delivery Application 320.

Website server 318 may represents any of a variety of information and services that are configured to provide content, including messages, over a network to another computing device. Thus, website server 318 can include, for example, a web server, a File Transfer Protocol (FTP) server, a database server, a content server, or the like. Website server 318 may provide the content including messages over the network using any of a variety of formats including, but not limited to WAP, HDML, WML, SGML, HTML, XML, Compact HTML (cHTML), Extensible HTML (xHTML), or the like.

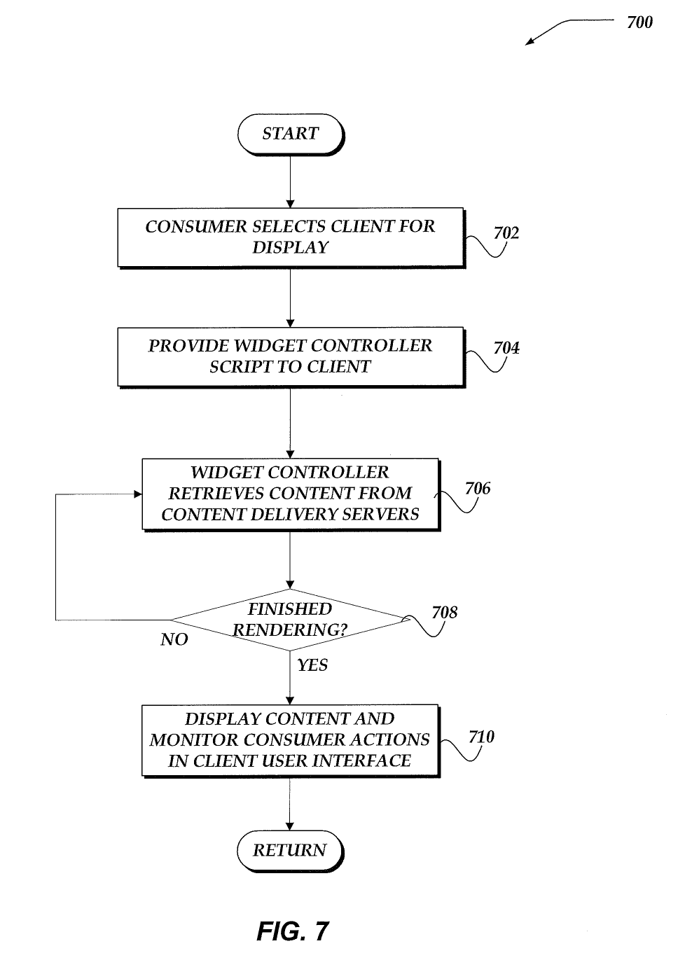

Content Management Application 319 may be configured to generate and/or provide, content (e.g., news, events, audio, video, advertisements, or the like), widget controllers, widgets, or the like, that may be hosted on Content Delivery Server Device 112, or the like. In at least one of the various embodiments, Content Management Application 319 may be operative on Content Management Server Device 114 of FIG. 1. In any event, Content Management Application 319 may employ processes, or parts of processes, similar to those described in conjunction with FIGS. 7-15, to perform at least some of its actions.

Content Delivery Application 320 may be arranged and configured to provide content to client devices. In at least one of the various embodiments, Content Delivery Application 320 may be operative on Content Delivery Server Device 112 of FIG. 1. In any event, Content Delivery Application 320 may employ processes, or parts of processes, similar to those described in conjunction with FIGS. 7-15, to perform at least some of its actions.

### Illustrative Logical System Architecture

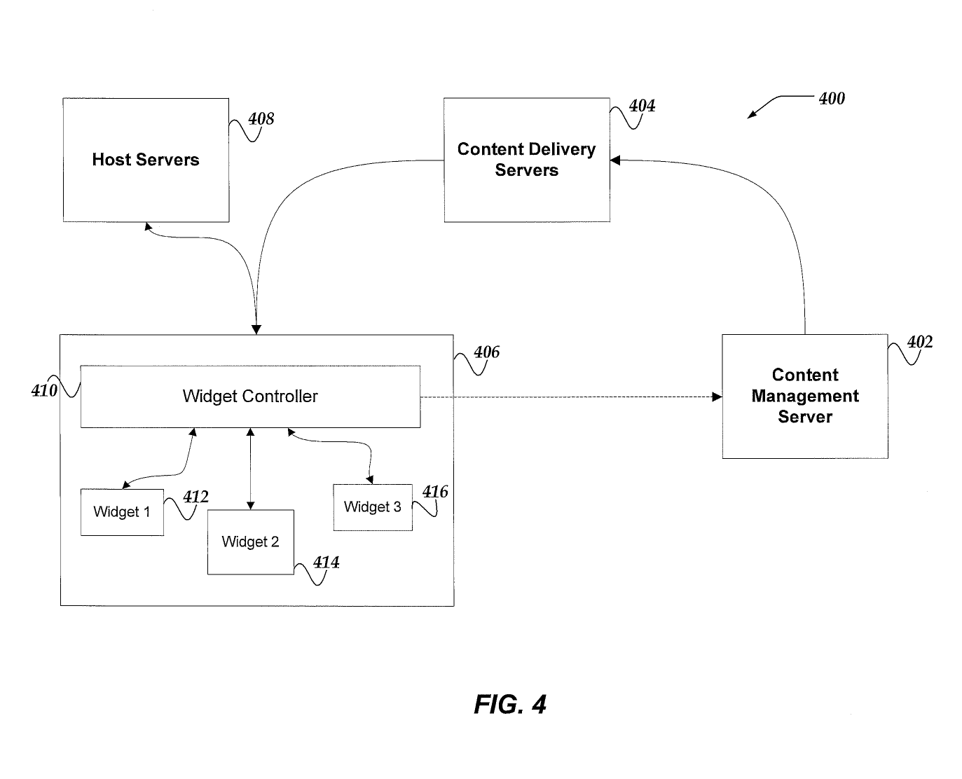

FIG. 4 illustrates a logical architecture of system 400 for hyper local targeting based on user locations in accordance with at least one of the various embodiments. In at least one of the various embodiments, various components may be arranged for delivery of content to users that may be targeted based on a determined hyper local location. In at least one of the various embodiments, such as system may include Content Management Server 402, Content Delivery Server 404, and client interface 406.

In at least one of the various embodiments, hyper local targeting based on user location may include providing content, such as, news, events, advertisements, coupons, or the like, to consumers that may be visiting digital media properties owned by various hosts. Such properties may include web pages, mobile applications, screensavers, electronic kiosks, or the like. Hosts may include commercial and/or non-commercial entities such as, news media outlets, online magazines, mobile application providers, educational institutions, or the like.

Hosts may often integrate hyper local targeting into existing digital properties to provide locally targeted content for consumers on behalf of merchants. For example, a television news website may be arranged to provide a wide range of content that is generally directed towards consumers located within a large regional viewing area.

However, it may be advantageous for content rich media properties to integrate with a hyper local targeting system, such as, system 400, that enables the media property to be further personalized to provide content relevant to localized interests of consumers at a neighborhood level.

Likewise, in at least one of the various embodiments, small neighborhood focused merchants may be inclined to purchase advertising space on large national or regional media properties that offer hyper local targeting features. Hyper local targeting of content may enable small businesses to purchase advertisements targeted to the neighborhood (hyper local region) where their business operates. Also, since hyper local targeting enables advertising audiences to be organized into small segments the price charged by hyper local targeted advertisements may be more affordable for small businesses. Absent hyper local targeting, many hosts may be unable to offer small businesses affordable advertisement buys because the large audience reach of the media properties.

Furthermore, not only might the cost of advertising to large audiences be expensive for small businesses, such large scale advertising, may target many consumers that are of little interest to small businesses. For example, a local coffee shop may find it unlikely to be cost effective to purchase digital advertising that reaches a large geographic region area since most of the shop's consumers may come from the neighborhood where the shop is located. Consumers that are far away from the coffee shop may likely prefer to frequent coffee shops that are closer to where they live and/or work. Thus, advertising to an entire metropolitan region may be cost prohibitive as well as inefficient for many small businesses and less desirable to their customers.

Also, for hosts that own and/or operate the various digital media properties, managing and integrating hyper local targeted content may be a difficult and expensive proposition. In some cases, hosts may be used to working a few large advertising providers and/or larger merchants. So identifying and integrating content from potentially hundreds of small business advertisers is likely to be beyond the technical capabilities (or at least beyond the amount of effort and/or budget they are willing to spend) of most hosts. Likewise, most digital advertising providers are not organized to effectively acquire and manage many hundreds of small business accounts. Further, determining and tracking the hyper local region to associating them with consumers may require innovations that may be otherwise unavailable using standard consumer management techniques.

In at least one of the various embodiments, if a consumer visits a digital media property that is integrated with a hyper local targeting system, such as, system 400, hyper local content presented to the consumer may include local news and events for the hyper local region (neighborhood) that the consumer may be associated with. The delivery of content that is relevant to a neighborhood, such as, news, events, or the like, may increase the relevance of a digital media property to consumers. Likewise, if the hyper local region of a consumer has been determined, targeted content such as, advertisements, coupons, or other merchant content may be provided to consumer.

In at least one of the various embodiments, Content Management Server 402 may be arranged to provide interfaces that enable users to perform actions to administer and configure the hyper local targeting system. Such actions may include, determining and/or generating the content that be delivered to clients, allocating merchants (advertisers) to hyper local regions (e.g., neighborhoods), collecting and analyzing usage metrics (e.g., consumer actions), or the like, or combination thereof.

In at least one of the various embodiments, content management server 402 may provide content to one or more content delivery servers 404. Such content, in at least one of the various embodiments, may include images, videos, audio, HTML, text, or the like. Also, in at least one of the various embodiments, content may include computer programs.

In at least one of the various embodiments, content delivery servers 404 may be arranged into high availability clusters and/or be operative on cloud based storage platforms, or the like. As such, content delivery servers 404 may be arranged to employ one or more well-known redundancy techniques to help ensure high availability and high performance, such as, replication servers, geographically separate mirroring, automatic scaling of virtual instances, automatic storage provisioning, load balancing, segmenting content based on host, or the like, or combination thereof.

In at least one of the various embodiments, content delivery servers 404 may be arranged to provide content upon request to one or more clients, such as, client 406. In at least one of the various embodiments, client 406 may request content from content delivery servers 404 using identifiers such as URIs, GUIDs, keys, or the like, to identify and/or locate the requested content. In at least one of the various embodiments, content delivery servers 404 may be arranged to respond to the content request by providing the content directly to the requestor. In some embodiments, content delivery servers 404 respond by returning the requested content absent performing any additional analysis or computation.

In at least one of the various embodiments, content delivery servers 404 may be arranged to be simple storage servers of for content provided by content management server 402. This arrangement may reduce costs and reduce failure risk by separating the content delivery from the content management. For example, content delivery servers 404 may be implemented using less expensive computing resources since they are not expected to perform complex computation or analysis.

Further, in at least one of the various embodiments, content delivery servers 404 may be arranged to enable to access to stored content by one or more well-known communication protocols, such as, HTTP, XML-RPC, SOAP, REST, or the like. Also, in at least one of the various embodiments, customized non-standard communication protocols may also be employed as needed. In at least one of the various embodiments, consistent with these protocols, log files, or the like, may be generated and made available for auditing content access.

In at least one of the various embodiments, clients 406 may be one or more applications operative on one or more client devices. Clients 406 may include, web browsers, mobile applications, native applications, or the like, that may be running on the client device. In at least one of the various embodiments, clients 406 may be a process running as one or more web pages in a consumer's web browser.

In at least one of the various embodiments, host servers 408 may be servers and applications operated by or on behalf of the host (e.g., news media web servers). The host servers may provide content to the client for display to the consumer. In at least one of the various embodiments, host servers 408 may support bi-directional communication with clients 406 depending on the type of client device and/or the type and purpose of the application running on the client devices.

In at least one of the various embodiments, the content on host servers 408 is generated and managed by the host (or on behalf of the host.) and provided to the clients. For example, host servers 408 may be running one or more web servers, such as, Apache HTTP Server, Internet Information Server, nginx, or the like, for providing content to clients 406 (e.g., which may be a web browser).

Also, in at least one of the various embodiments, host servers 408 may be providing backend services to one or more mobile applications or native desktop applications. In at least one of the various embodiments, host server 406 may be in communication with a mobile application and/or desktop application to provide content, and/or receive input from a consumer who is using the mobile application and/or desktop application.

In at least one of the various embodiments, if client 406 downloads content from host servers 408, that content may include information (e.g., programs, links, tags, or the like) that enable the client to request content from content delivery servers 404. For example, in at least one of the various embodiments, if the client is a web browser, the downloaded control may include a HTML script tag that references content located on content delivery servers 404. In this case, a program, such as a JavaScript script, may be retrieved from content delivery servers 404 to begin executing on the client.

For at least one of the various embodiments, widget controller 410 may be an example of a program downloaded from content delivery servers 404. In at least one of the various embodiments, widget controller 410 may be arranged to begin executing after it is downloaded to the client. In at least one of the various embodiments, widget controller 410 may be arrange identify and instantiate one or more widgets on the client, such as, widget 412, widget 414 and widget 416.

In at least one of the various embodiments, widgets may be areas on the client that are designated to hold (display) various content for the client. For example, widget 412 may be arranged and/or configured to display local news, widget 414 may be arranged and/or configured to display local events, or widget 416 may be arranged and/or configured to display targeted advertisements. In at least one of the various embodiments, widget controller 410 may locate the widgets and coordinate the delivery, display, and operation of the content for each widget.

For example, in at least one of the various embodiments, if client 406 is a web browser, widget controller 410 may be a JavaScript program and widget 412, widget 414, widget 416 may be HTML elements such as DIV's, IFRAME's or other script tags, or the like.

In at least one of the various embodiments, if HTML, CSS, and JavaScript is supported by the client, well-known techniques for selecting elements and installing content into each relevant element of the page (the widgets) may be performed by widget controller 410.

In at least one of the various embodiments, for non-HTML based clients, such as, some mobile applications, other well-known techniques that are appropriate for the platform may be employed. For example, an IOS based mobile application may have one or more view object that may be arranged to be widgets where content may be dynamically deployed by widget controller 410 that may be operating within the content of the mobile application.

In at least one of the various embodiments, as consumers interact with the widgets displayed on the client, the widget controller may monitor the interactions and send metrics relating to these interactions to content management server 402. Accordingly, content management server 402 may determine that the content should be changed or updated. If so, content changes may be pushed to content delivery servers 404.

In at least one of the various embodiments, at least some the metrics provided to content management server 402 may be used for determining the hyper location of the consumer that is interacting with the client. Also, in at least one of the various embodiments, content management server 402 may retrieve and analyze audit logs that may be generated by content delivery server 404. Analysis of the audit logs produce information that may be useful for determining the location of one or more consumers.

In at least one of the various embodiments, consumer interaction with client 406 may trigger new or updated content to be retrieved from content delivery servers 404. The new/updated content may be provided to the client and processed as before. In at least one of the various embodiments, the updated content may include a modified widget controller, as well as, static content updates, such as images, videos, audio, text, HTML, or the like. Thus, content management server 402 may modify the widget controller and widgets absent any interaction and/or dependency on host servers 408.

In at least one of the various embodiments, content management server 402 may employ various metrics, including log files, to determine the location of consumers, for allocating merchants to local regions, for rank ordering of content, or the like.

In at least one of the various embodiments, depending on security policies, the interaction between the client and content delivery servers 404 may be proxied through other servers, such as, host servers 408 using one or more well-known techniques, such as, URL rewriting, or the like. In other cases, clients may submit content requests directly to the content delivery servers. Likewise, in at least one of the various embodiments, interaction between clients 406 and content management servers 402 may be direct and/or proxied.

One of ordinary skill in the art will appreciate that the architecture of system 400 is a non-limiting example that is illustrative of at least a portion of at least one of the various embodiments. As such, more or less components may be employed and/or arranged differently without departing from the scope of the innovations described herein. However, system 400 is sufficient for disclosing at least the innovations claimed herein.

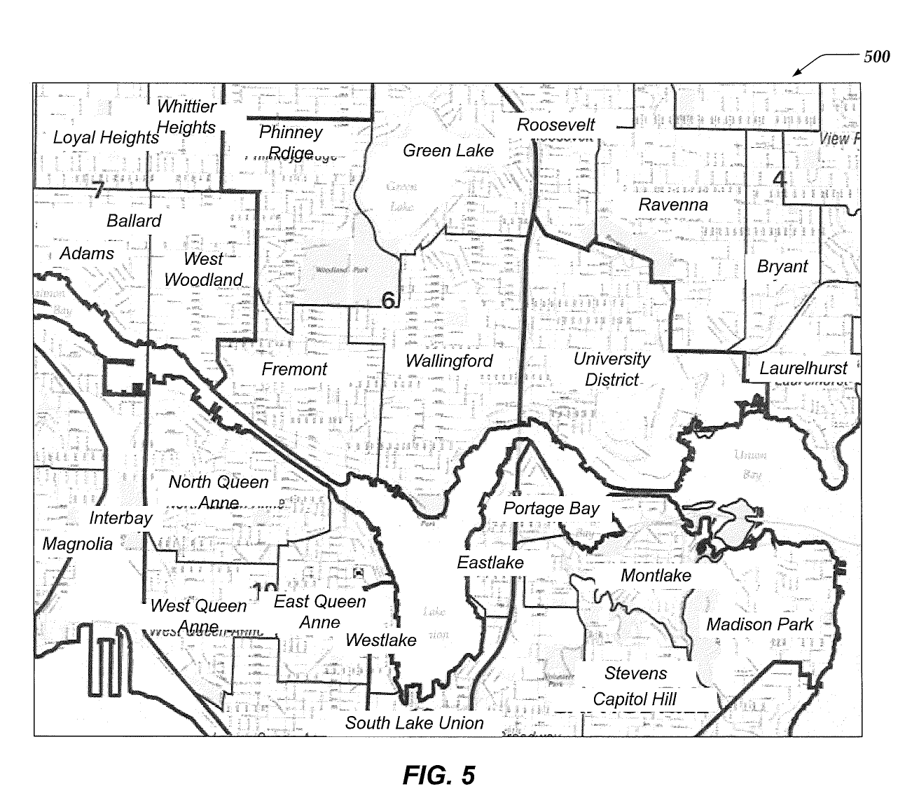

FIG. 5 illustrates an example of hyper local region map 500 in accordance with at least one of the various embodiments. In at least one of the various embodiments, hyper local regions may be geographic regions that are generally of a finer resolution that can be obtained from IP addresses, Postal code, or the like. In some case, hyper local regions may be “unofficial” in the sense that they might not be recognized by official government agencies. A common type of hyper local region is a neighborhood, neighborhoods may be well defined to merchants and consumers but determining the neighborhood that a consumer or merchant may be located may require special techniques.

Map 500 is an example that shows hyper local regions included in a portion of Seattle, Wash. In this example, Map 500 illustrates over 20 hyper local regions (e.g., neighborhoods) in the small portion of Seattle shown in map 500 (e.g., Fremont, Wallingford, Ravenna, and so on). While each hyper local region may represent a small part of a larger metropolitan area, hyper local regions, such as, neighborhoods may be relevant to the consumers that live and/or work therein as well as the merchants that service them.

In at least one of the various embodiments, a variety of techniques may be employed for determining the hyper local regions that may be relevant to an individual consumer. In at least one of the various embodiments, content management application 319 may be arranged to determine the hyper local region for one or more consumers based on inferences that may be made from one or more metrics that may be associated with consumer actions. In at least one of the various embodiments, consumers may be presented with a user interface that enables them to select the hyper local regions (e.g., neighborhood) that they consider relevant. Traditional methods of IP targeting may assist in defaulting the list of possible hyper-local regions. Consumers may pick from a hierarchy of locations such as city first and then be presented the neighborhoods with in the city. Consumers may be enabled to type in a zipcode first and then be presented a list of nearby neighborhoods to select from.

Likewise, in at least one of the various embodiments, merchants may be associated with one or more neighborhoods such that their content, such as, advertisements, are directed towards consumer determined to be in relevant hyper local regions.

In at least one of the various embodiments, users may employ a content management application, such as, content management application 402, to generate the boundaries for hyper local regions. In some embodiments, third party data sources that include pre-defined geographic boundaries may be employed (imported). In at least one of the various embodiments, users may generate and/or modify the size and scope of the geographic boundaries of the hyper local regions.

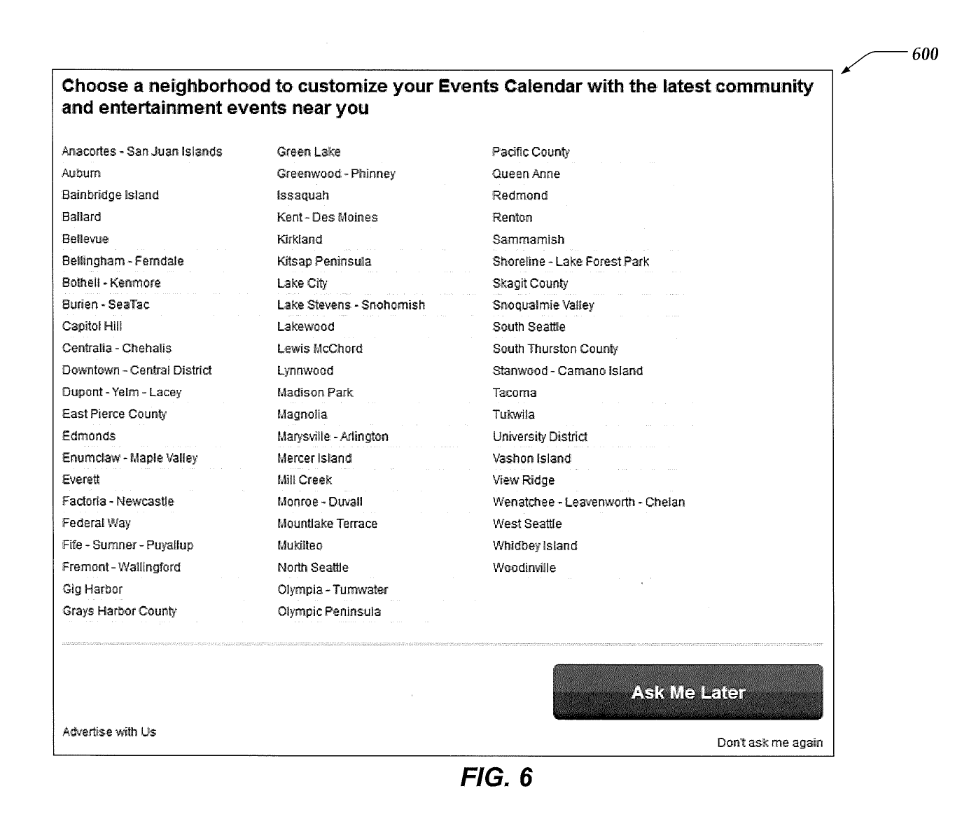

FIG. 6 illustrates user interface 600 that enables a consumer to select one or more hyper local regions in accordance with at least one of the various embodiments. In this example, a user interface may be displayed having links for each relevant hyper local region. In this example, a user could select the hyper local region that they may be interested in, or they can dismiss the user interface if they do not want to make a selection. For example, as shown in FIG. 6, a host that operates a digital media property directed at the Seattle metropolitan area may be configured to display a user-interface that lists hyper local regions, such as, neighborhoods that may be relevant to the Seattle metropolitan area. Accordingly, digital media properties targeting different metropolitan areas may offer different hyper local regions for consumers to select. Also, in at least one of the various embodiments, digital media properties targeting audiences in the same metropolitan area may show the same hyper local regions. Alternatively, in at least one of the various embodiments, slightly different shaped regions, though similar, may be represented by the same region name based in part on which digital media property and/or partner is being accessed by a consumer.

Furthermore, in at least one of the various embodiments, if a digital media property targets more than one metropolitan area, the appropriate lists of hyper local regions may be determined based on the consumers general location. In at least one of the various embodiments, the consumers general location may be determined based on geo-location information associated with the consumers IP address, host server supplied information, or the like.

### Generalized Operation

The operation of certain aspects of the invention will now be described with respect to FIGS. 7-15. In at least one of various embodiments, processes 700, 800, 900, 1000, 1100, 1200, 1300, 1400 and 1500 described in conjunction with FIGS. 7-15, respectively, may be implemented by and/or executed on a single network device, such as network device 300 of FIG. 3. In other embodiments, these processes or portions of these processes may be implemented by and/or executed on a plurality of network devices, such as network device 300 of FIG. 3. Likewise, in at least one of the various embodiments, processes 700, 800, 900, 1000, 1100, 1200, 1300, 1400 and 1500, or portions thereof, may be operative on one or more client devices, such as client device 200. However, embodiments are not so limited, and various combinations of network devices, client devices, virtual machines, or the like may be utilized. Further, in at least one of the various embodiments, the processes described in conjunction with FIGS. 7-15 may be operative in system with logical architectures such as those described in conjunction with FIGS. 4-6.

FIG. 7 is an overview flowchart for process 700 that provides content to consumers based on hyper local targeting in accordance with at least one of the various embodiments. After a start block, at block 702, in at least one of the various embodiments, a consumer may select a client application operative on a client device for display. In at least one of the various embodiments, a client application or client device that may be accessed by a consumer may begin preparing to the display content to the consumer. In at least one of the various embodiments, accessing the client may accomplished by visiting a web page of a host's website, loading and/or running a mobile application that may be associated with a host, or the like.

In at least one of the various embodiments, if the client is a web browser, the client may be provide a HTTP request to a host server to retrieve the HTML for the web page. As the HTML is received, the client may begin parsing the HTML and preparing it for display.

In at least one of the various embodiments, if the client is accessing a user-interface that is integrated with a hyper local targeting system, it may be indicated by the existence of a link or tag indicating that content is available to be fetched from a content delivery server.

At block 704, in at least one of the various embodiments, a widget controller may be provided to the client. In at least one of the various embodiments, for web browser clients, the widget controller may be a program that is retrieved using a HTML script tag. In at least one of the various embodiments, the tag used for identifying and retrieving the widget controller, may include one or more values that may be used to identify the particular program (script) that should be used, and/or values that may be used as input parameters if the widget controller becomes operative on the client. For embodiments that may use HTML, the “src” (source) attribute of the script tag may be include URL that includes one or more parameters.

In at least one of the various embodiments, the operation of retrieving the widget controller may include generating a request that may be sent a content delivery server. In at least one of the various embodiments, the request may be formulated to include a consumer profile corresponding to the consumer, or information that may be used to identify the consumer profile that corresponds to the consumer.

At block 706, in at least one of the various embodiments, optionally, the widget controller may make further requests to the content delivery servers to fetch and/or retrieve content for use on the client display. In at least one of the various embodiments, during the display rendering, the widget controller may be operative to perform various tasks such as fetching content, caching content, locating widgets, modifying widgets, or the like.

In at least one of the various embodiments, the widget controller may be downloading content from a content delivery server, where such as content may include, images, video, audio, text, source code, computer programs, or the like, for advertisements, coupons, news stories/articles, events, or the like.

In at least one of the various embodiments, the widget controller may be arranged to generate a request that may be sent a content delivery server to retrieve the content from the content delivery. In at least one of the various embodiments, the request may be formulated to include a consumer profile corresponding to the consumer, or information that may be used to identify the consumer profile that corresponds to the consumer.

At decision block 708, in at least one of the various embodiments, if the client has finished rendering the user-interface for display, control may flow to block 710; otherwise, control may loop back to the block 706.

At block 710, in at least one of the various embodiments, the widget controller may perform actions that direct or deploy the content provided by the content delivery servers to be executed and/or displayed in one or more widgets that may be located in the client display/user-interface. In at least one of the various embodiments, the widget controller may also monitor consumer interactions with the one or more widgets in the client user-interface. Next, control may be returned to a calling process.

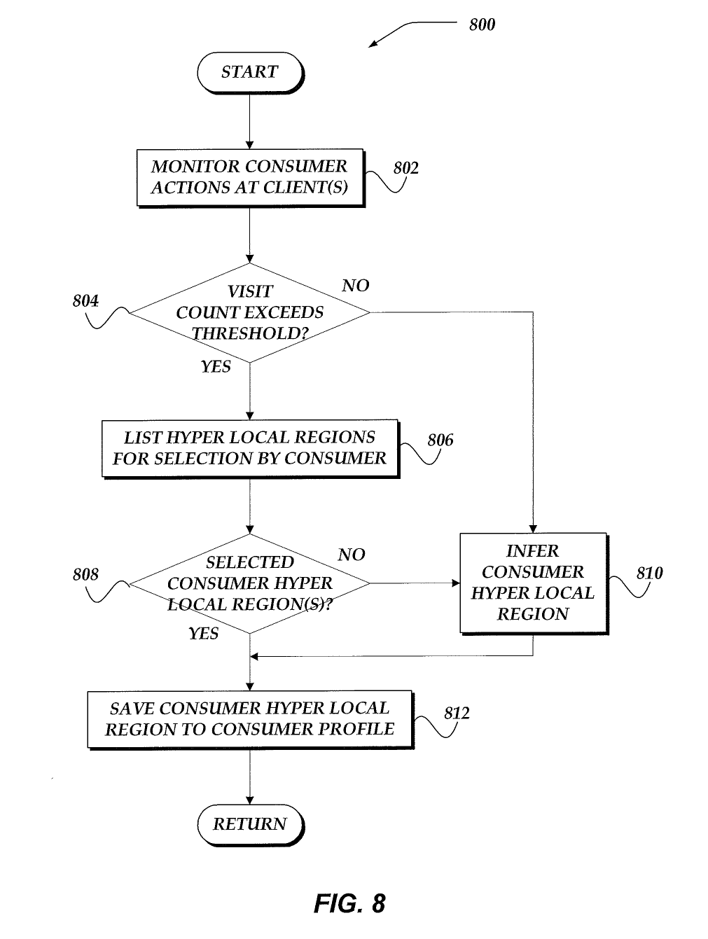

FIG. 8 is a flowchart for process 800 for determining user location in accordance with at least one of the various embodiments. After a start block, at block 802, in at least one of the various embodiments, the actions of a consumer visiting a client may be monitored by a widget controller that may be running on the client. In at least one of the various embodiments, if a client is a web browser or other HTTP user-agent, one or more HTTP cookie values corresponding to a consumer may be maintained for associating monitored actions with a consumer. Further, if HTTP cookies may be unavailable, other techniques such as determining consumer identity using a combination of IP address, HTTP user-agent header, other HTTP header values, time-of-day, or the like, may be employed to generate an identifier for the consumer.

In at least one of the various embodiments, at least of the monitored metrics may be the number of time a consumer visits the user-interface. Visit count may be monitored using one or more well-know methods, such as, HTTP cookies, or the like.

At decision block 804, in at least one of the various embodiments, if a visit count exceeds a defined threshold, control may flow to block 806; otherwise, control may flow to block 801. In at least one of the various embodiments, a visit count may be tracked for each consumer that visits the client. In at least one of the various embodiments, HTTP cookies may be employed identify the consumer and track the number of visits an individual consumer has made to the client. Thus, the track visit count may be compared to known and/or defined threshold value, such as, ten, as in ten visits to the client by the particular consumer. In at least one of the various embodiments, the current visit count may be saved a field in a HTML cookie that is stored on the client. In other embodiments, the visit count information may be saved on in database, or the like, on the Host server, content management server, content delivery server, or the like.

In at least one of the various embodiments, process 800 may be arranged to record a time range as well as visit count, such that exceeding the visit count threshold within a defined time span, such as, 72 hours, may the condition for sending control to block 806. For example, in at least one of the various embodiments, process 800 may be configured to advance to block 806 if a consumer has visited the client three times in seventy-two hours.

At block 806, in at least one of the various embodiments, since the condition in decision block 804 is met, a user-interface for selecting a hyper local region may be displayed to the consumer. In at least one of the various embodiments, the hyper local regions that may be available for a consumer may be presented in a list or similar arrangement. In at least one of the various embodiments, the user interface may be similar to the one illustrated by FIG. 6.

In at least one of the various embodiments, selection of hyper local regions may be enabled using hyper-links embedded in the user-interface, buttons, checkboxes, or the like.

At decision block 808, in at least one of the various embodiments, if the consumer selects a hyper local region, control may flow to block 812. Otherwise, in at least one of the various embodiments, control may flow to block 810. In at least one of the various embodiments, the user interface displayed for selecting the consumer's hyper local region may be arranged such that a consumer may dismiss the user-interface before indicating a hyper local region. Alternatively, in at least one of the various embodiments, the client application may be arranged to require consumers to select a hyper local region before they can continue using the client application.

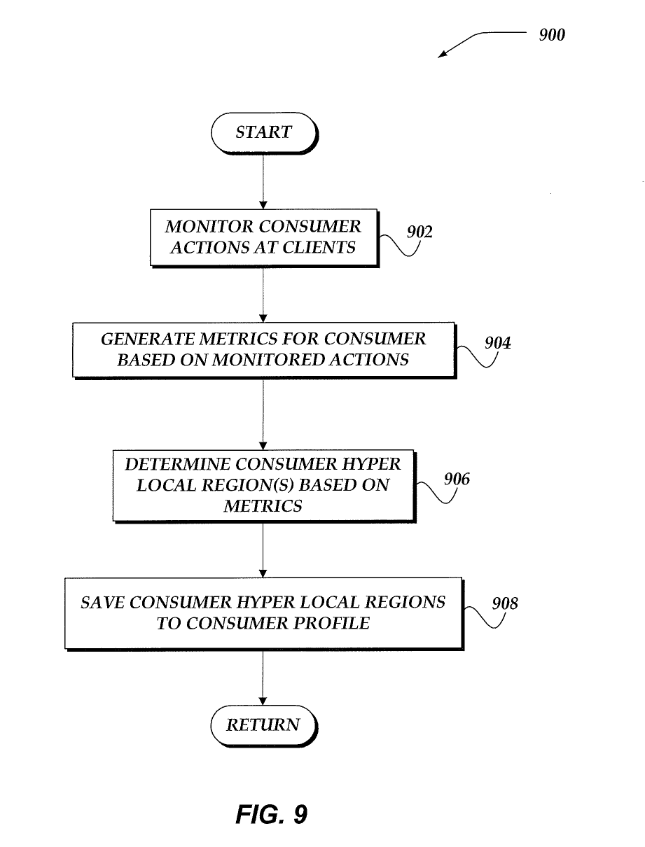

At block 810, in at least one of the various embodiments, since the consumer dismissed the selection user-interface without selecting a hyper local region, the content management application may use one or more techniques to determine a hyper location region to associate with the consumer based in part on inferences based on one or more metrics. (See, FIG. 9).

At block 812, in at least one of the various embodiments, the consumer hyper local region information may be added to a consumer profile and saved to storage. In at least one of the various embodiments, the consumer profile may be a data structure stored at the Host server, content delivery server, or content management server. In at least one of the various embodiments, the widget controller may generate the consumer profile data structure and store it on the content delivery server for future use. Next, in at least one of the various embodiments, control may be returned to a calling process.

FIG. 9 is a flowchart for process 900 for determining user's hyper location region in accordance with at least one of the various embodiments. After a start block, at block 902, in at least one of the various embodiments, the actions of consumers visiting clients may be monitored. In at least one of the various embodiments, monitoring may include information provided by a widget controller that is running on a client. Also, in at least one of the various embodiments, monitoring may include processing one or more log files that may be associated with the content delivery servers. In at least one of the various embodiments, monitored actions may include viewing or interaction with widgets and/or widget content.

In at least one of the various embodiments, interactions may include the selection of a particular news story or event. If the hyper local region for a consumer is undetermined, a widget that includes news content may display news stories from a plurality of hyper local regions. Accordingly, the widget controller may monitor which news stories are selected and which hyper local region is associated with the selected news stories. Likewise, widgets displaying event content associated with a plurality of hyper local regions may be displayed and similarly monitored.

At block 904, in at least one of the various embodiments, one or more metrics may be tabulated and/or computed based on the monitored consumer actions. In at least one of the various embodiments, these actions may occur in a single web session or spread out over multiple days. In at least one of the various embodiments, the content management application may be arranged to perform one or more computations for generating metrics.

In at least one of the various embodiments, other metrics may include search key words used by consumers if searching for events or news stories, duration of viewing content, forwarding of content to other consumers, signing up for neighborhood newsletters, or the like

In at least one of the various embodiments, the content management application may analyze one or more log files generated by the content delivery servers. Even though content delivery server may be arranged to provide simple storage, audit/access logs that record consumer and/or widget controller requests for content may be generated.

In at least one of the various embodiments, the content management application may download the one or more log files from the content delivery servers. Or, in at least one of the various embodiments, the content delivery server may continuously forward the log files to the content management server (or to other storage locations accessible to the content management server).

In at least one of the various embodiments, the log files may be analyzed to determine which content may be access by a consumer. As above, consumers may be identified using HTTP cookie, HTTP user-agent header values, IP addresses, or the like, or combination thereof.

At block 906, in at least one of the various embodiments, hyper local region(s) for the consumers may be determined based at least in part by the tabulated metrics. In at least one of the various embodiments, the importance of various monitored actions may be weighted based on relevance. For example, if a consumer selects and views a news articles from a particular hyper local region it may be strong indicator that they are interested in this hyper local region. For example, printing a coupon for a neighborhood merchant may be weighted as more important than simply viewing news for a neighborhood. Also, in at least one of the various embodiments, a consumer that may be mobile user may share their current location with the mobile application and the physical location of the phone (Latitude/Longitude) may be employed to represent the location of the consumer.

In at least one of the various embodiments, the hyper local region that is computed as having the highest score may be determined to be the hyper local region to associate with a consumer. In at least one of the various embodiments, at least one hyper local region must exceed a defined threshold to determine a hyper location region for a consumer. In some embodiments, if the threshold is not exceeded the hyper local region for the consumer may remain indeterminate.

At block 908, in at least one of the various embodiments, the consumer hyper local region information may be added to a consumer profile data structure and saved to storage. In at least one of the various embodiments, consumer profile information may be stored in database that may be accessible to the content management application. The consumer profile may be implemented using one or more well-known data structures, and may be used to track one or more attributes of a consumer, including, hyper local region, number of visits to host servers, merchant interactions, or the like.

In at least one of the various embodiments, the determination of a hyper local region for a consumer based on metrics and inference may be overridden if the consumer identifies one or more hyper local regions. For examples, the consumer may identify a hyper local region using interfaces 500 in FIG. 5. In at least one of the various embodiments, the hyper local region identified by a consumer may override the inferred determination of a hyper local region. Thus, in at least one of the various embodiments, the consumer profile may not be updated if the consumer has identified a hyper local region. In at least one of the various embodiments, if the consumer profile contains enough implied location actions, an application, such as, the widget controller, may prompt the consumer to input if they would like to make the strongest location their current hyper local region or may set it automatically. In at least one of the various embodiments, determining a strongest location may be determined based on the number of actions that may be associated with the consumer and are associated with the location.

In at least one of the various embodiments, consumer profiles may be based on the aggregation of actions for a plurality of individual users. In at least one of the various embodiments, aggregated consumer profiles may be generated if metrics that enable individualized consumer profiles may be unavailable. For example, in at least one of the various embodiments, multiple consumers accessing a host's digital property from behind a router using Network Address Transaction (NAT) may be indistinguishable from each other absent additional individualized information. In this case, a single consumer profile may be generated to represent the indistinguishable consumers. Also, in at least one of the various embodiments, consumer profiles may be aggregated deliberately based on one or more policy based rules and/or configuration value. Next, in at least one of the various embodiments, control may be returned to a calling process.

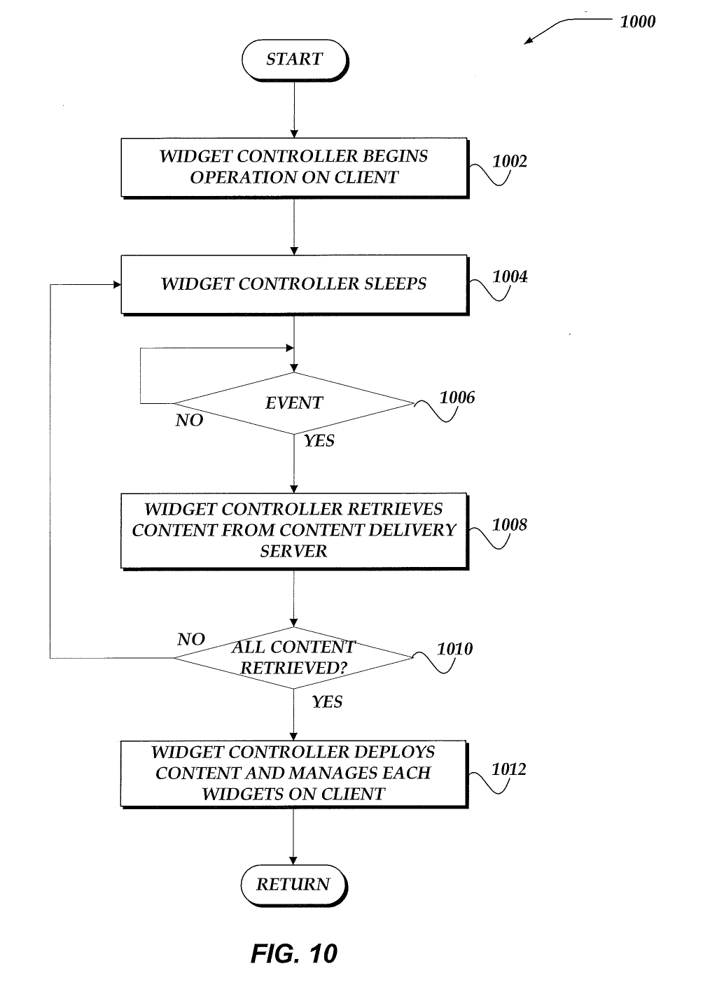

FIG. 10 is a flowchart for process 1000 for delivering content and loading content into widgets in accordance with at least one of the various embodiments. After a start block, at block 1002, in at least one of the various embodiments, the widget controller that may have been provided to a client may begin operation (running) on the client. In at least one of the various embodiments, the widget controller may be arranged such that it may be downloaded and launched on the client before widget content may be downloaded.

In at least one of the various embodiments, the initial download of the widget controller may be a small lightweight program that includes just enough code to instantiate itself and register/link with the client it is being hosted within. In at least one of the various embodiments, this may enable the client to continue being responsive to consumers, rather than having to wait for the entire widget controller to download.

At block 1004, in at least one of the various embodiments, the widget controller may yield control and put itself to sleep. In at least one of the various embodiments, for some operations client devices and/or application may have a single thread of control. Thus, during single threaded operation only one program, script, or the like, may be operative. Since the loading, setup, and other tasks of a widget controller may take a long and/or indeterminate time to complete, the widget controller immediately may register an event and yield control so other components that may be operative in the client application may continue processing. In at least one of the various embodiments, the registered event may be a timer event that may be configured to fire after a fixed time has elapsed. For example, time event may be configured to fire every 5 seconds.

In at least one of the various embodiments, registering with an event may involve associating a callback function that is called when the event fires. The call back function may be arranged to wake up the widget controller so it can continue to perform actions.

In at least one of the various embodiments, the widget controller may be arranged to start downloading content immediately. In at least one of the various embodiments, it may determine that it should yield based in part on the amount of content that must be downloaded. Or, in at least one of the various embodiments, it may be arranged to download a minimum portion of content before yielding controller to the client application and/or client device.

At decision block 1006, in at least one of the various embodiments, if an event associated with the widget controller is triggered, control may flow to block 1008; otherwise, in at least one of the various embodiments, control may loop back to decision block 1006.

At block 1008, in at least one of the various embodiments, the widget controller may resume performing actions to retrieve content from the content delivery server.

In at least one of the various embodiments, upon waking up the widget controller may continue performing actions such as downloading content from the content delivery servers, locating widgets, or the like. In at least one of the various embodiments, the widget controller may be arranged to perform a limited number of content downloads, or other tasks before putting yielding control and putting itself back to sleep. In at least one of the various embodiments, the widget controller may download content that includes additional source code and/or executable code from the content delivery servers. Thus, the initial size of the widget controller may be minimized to help avoid the widget controller from causing delays or performance slowdowns during the initial start up of the client application.

In at least one of the various embodiments, the widget controller may be arranged to generate a request that may be sent a content delivery server to retrieve the content from the content delivery. In at least one of the various embodiments, the request may be formulated to include a consumer profile corresponding to the consumer, or information that may be used to identify the consumer profile that corresponds to the consumer.

At decision block 1010, in at least one of the various embodiments, if the widget controller determines that relevant content has been provided by the content delivery server, control may flow to block 1012; otherwise, control may loop back to block 1004.

In at least one of the various embodiments, the widget controller may be arranged to employ various method for determining if all the content has been downloaded. For example, a portion of the content may be a list or manifest that includes a list of content to retrieve from the content delivery servers. If each portion of content listed in the manifest has been provided by the content delivery server, control may flow to block 1012.

At block 1012, in at least one of the various embodiments, the widget controller may deploy the provided content and begin managing and monitoring each of the one or more widgets that may be hosted within the client application. In at least one of the various embodiments, some widgets may be arranged such that they may individually load their content on demand. For example, a widget that displays video content may be arranged to defer requesting the video content from the content delivery server until a consumer begins to view the video.

Next, in at least one of the various embodiments, control may be returned to a calling process.

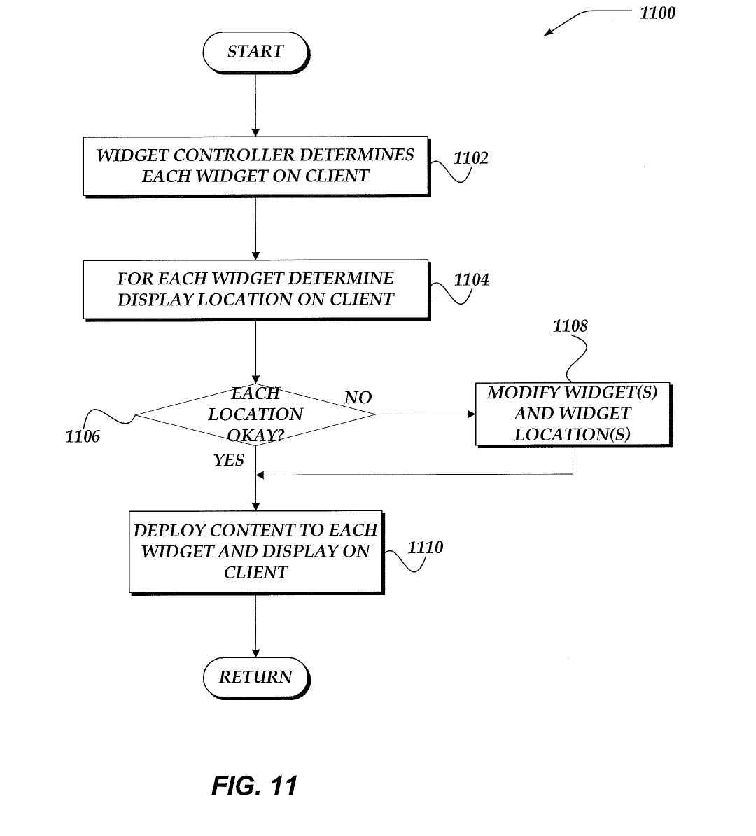

FIG. 11 is a flowchart for process 1100 for locating widgets into a client user interface in accordance with at least one of the various embodiments. After a start block, at block 1102, in at least one of the various embodiments, the widget controller determines each widgets for the current user-interface. In at least one of the various embodiments, the widget controller may be arranged to identify the widgets and/or widget locations for the client application. The method for identifying widgets may vary depending on the type of client application the widget controller may be hosted within.

For example, in at least one of the various embodiments, clients that support HTML, JavaScript, and CSS, (such as modern web browsers) may employ one or more well-known techniques for Document Object Model (DOM) traversal. Thus, DOM objects that include attributes indicating that the object is a widget may be identified and located. In some embodiments, such attributes may include the id, class, name, or the like, of the DOM object. Further, in at least one of the various embodiments, the locating of widgets may be facilitated using one or more programming toolkits, such as, JQuery, Ext, Prototype, NodeJS, BScript, or the like. Programming toolkits may enable additional methods for identifying widgets, such as, regular expressions, selectors, or the like.

In at least one of the various embodiments, the widget controller may be embedded in a mobile application or other native application. In these native applications, widgets may be located by traversing object trees that may comprise the user-interfaces of the applications. For example, in IOS there are various well-known methods to traverse and locate user-interface views (UIViews) that may be used for displaying widget content. Likewise, Android mobile operating system supports similar methods for finding and traversing user interface elements within an application. Thus, a widget controller may employ native user-interface frameworks to locate and identify widgets.

At block 1104, in at least one of the various embodiments, the proposed display location within the display may be determined by the widget controller. In at least one of the various embodiments, a widget and/or a widget location may be identified the widget controller may interrogate the widget to determine its proposed display size and display location in the client application. In at least one of the various embodiments, the widget controller may use built-in API's and attributes of the client application to collect this information. For example, if the client is a web browser, a widget may be assigned to a DIV element. In standard HTML DIV elements have various geometry attributes that may accessed by the widget controller, such as, style.height, style.width, style.padding, style.margin, style.z-order, or the like. Likewise, non-HTML client applications may have similar geometry attributes that may be obtained using other well-known API's that are native to an application. Also, in at least one of the various embodiments, the widget controller may access user-interface elements nearby the widget and/or those that enclose the widget.

At decision block 1106, in at least one of the various embodiments, if the location is adequate for display and operation of the widget(s), control may flow to block 1110; otherwise, control may flow to block 1108. In at least one of the various embodiments, using the geometry information collected about each widget, the widget controller may compute if the widget content that is destined for each widget is appropriate given the geometry of the widget. For example, the widget controller may have downloaded an image from the content delivery server that exceeds the geometry of the widget location that it is assigned. Or, in at least one of the various embodiments, the widget controller may determine that one or more widget may over lap if the content is loaded, and, so on.

In at least one of the various embodiments, the particular geometry and/or layout rules may be based in part on policy driven rules that may be downloaded by the widget controller. As such, the rules may be adapted for different client application hosts (e.g., desktop, mobile, browser, or the like), different client environments (e.g., web browser types, operating systems, languages/locales, or the like), different merchants/merchant types, different consumers, or the like.

At block 1108, in at least one of the various embodiments, the widget controller may perform operations to modify the widgets and/or the display areas to correct for deficiencies that were determined. In at least one of the various embodiments, the widget controller may make one or more modifications to the content to accommodate the geometry considerations. In at least one of the various embodiments, content may be scaled to fit within the available geometric constraints. Also, in at least one of the various embodiments, alternative content may be selected and/or downloaded. For example, if a 400 pixel square image does not fit, the widget controller may substitute text-only content that may fit better in the available space.

In at least one of the various embodiments, the widget controller may modify non-widget portions of the client application user-interface to better accommodate widget content. Also, the widget controller may modify other widgets and widget geometry to accommodate the current widget. For example, in at least one of the various embodiments, the widget controller may determine that three widgets that may be designated to align vertically may not fit within the available geometry. To accommodate the available geometry the widget controller may modify the alignment of the widgets such that the may be aligned horizontally rather that vertically.

Further, the widget control may be arranged to submit one or more reports to the content management server indicating success and/or failure of widget layouts. This may enable the content management server to notify the appropriate users that the widget layout for a given merchant/client/host combination may have problems.

In at least one of the various embodiments, the particular geometry and/or layout rules may be based in part on policy driven rules that may be downloaded by the widget controller. As such, the rules may be adapted for different client application hosts (e.g., desktop, mobile, browser, or the like), different client environments (e.g., web browser types, operating systems, languages/locales, or the like), different merchants/merchant types, different consumers, or the like.

At block 1110, in at least one of the various embodiments, the widget controller may deploy the content to each widget and/or otherwise activate the widgets for use in the user-interface. In at least one of the various embodiments, if the location and layout of the widget is resolved the content may be provided to widget and/or the widget may be activated. In some cases, in at least one of the various embodiments, widgets may be suppressed (not activated, not filled with content, or the like) if the geometric layout/location issues are not resolved by the widget controller. Next, control may be returned to a calling process. In at least one of the various embodiments, widgets may be processed in parallel or in groups of two or more. In some cases widgets may be arranged into groups and processed together as a group.

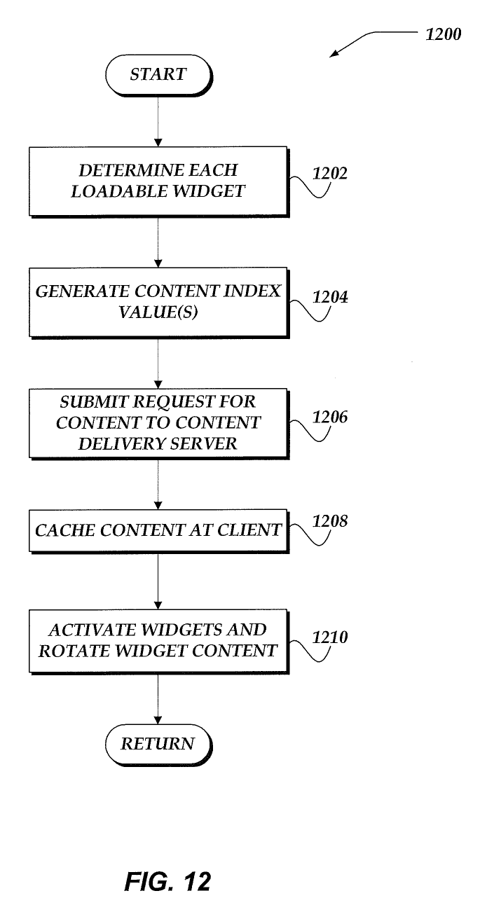

FIG. 12 is a flowchart for process 1200 for selecting and/or rotating content that is displayed at a client user interface in accordance with at least one of the various embodiments. After a start block, at block 1202, the widget controller may determine each loadable widget (e.g., widget that requires content to be downloaded and/or displayed). In at least one of the various embodiments, the widget controller includes instructions that define the content that should be downloaded. These instructions may be embedded in the widget control, or the widget controller may download lists or manifests that identify the content for downloading.

At block 1204, in at least one of the various embodiments, the widget controller may generate a series of content index values. In at least one of the various embodiments, content index values may be used in part for referencing content that is located on the content delivery servers.

In at least one of the various embodiments, the content may be stored on content delivery servers. In some embodiments, the content on the content delivery servers may be arranged such that they may be segmented into different locations based on the host server that the content may be associated with. In at least one of the various embodiments, within each host segment, content may be further segmented by hyper local region, content type (e.g., news, events, computer programs/scripts, images, text, videos, or the like), merchant type (e.g., florist, dentist, bakery, or the like), client type (device/application), time-of-day, or the like. In at least one of the various embodiments, within a segment, each portion of available content may be associated with an index value (e.g., an integer, string, and so on).

In at least one of the various embodiments, in the cases where the widget controller is selecting randomized content, such as, advertisement content and/or coupon content, the widget controller generate one or more index values. In such cases, the widget controller may generate index value based on random values. Or, in at least one of the various embodiments, the widget controller may generate index values based on one or more policy based rules, such selecting content in order rather than random.

At block 1206, in at least one of the various embodiments, the widget controller may submit request for content to the content delivery server. In at least one of the various embodiments, the widget controller may format a request command using the generated index values. This command may be submitted to the content delivery server to retrieve the requested content. For example, in at least one of the various embodiments, the widget controller may make one or more HTTP requests to content delivery server to retrieve one or more pieces of content. As discussed above, HTTP requests from the widget controller may be proxied through the host server, or the like.

At block 1208, in at least one of the various embodiments, content provided by the content delivery server may be cached at the client. In at least one of the various embodiments, if the client is a web browser (or other HTTP user-agent) content may be cached using well-known and/or built-in caching techniques.

At block 1210, in at least one of the various embodiments, the widget controller may determine which widgets should be activated and do so. Also, the widget controller may determine which widgets may need to rotate their content before being displayed. In at least one of the various embodiments, the widget controller may enforce policy rules that prevent advertising content from the same merchant type (e.g., florists) begin displayed for the same hyper local region at the same time to the same consumer. Thus, if such a conflict is determined, the widget controller may rotate the content before it is displayed. If appropriate content is available in the client cache it may be used, otherwise the widget controller may request additional content from the content delivery server.

In at least one of the various embodiments, if a consumer refreshes/resets the client application view, the widget controller may rotate the widget content, either by selecting content from a local cache, or requesting additional content from the content delivery server.

In at least one of the various embodiments, the widget controller may rotate content by randomly generate index values within a defined range or, in some cases, it may the index value may be computed based on policy rules. For example, a policy rule may indicate that the “next” index value in a sort order should be used rather than randomly selecting an index value. Next, in at least one of the various embodiments, control may be returned to a calling process.

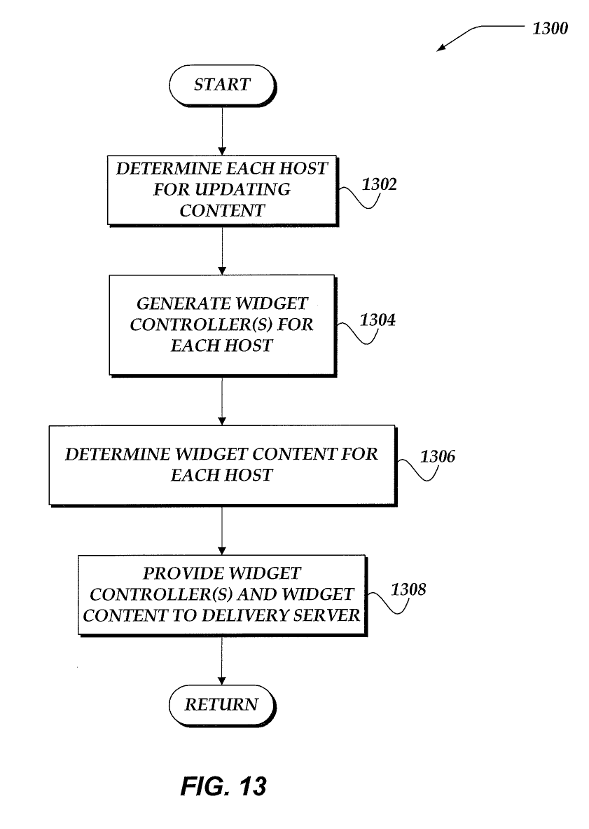

FIG. 13 is a flowchart for process 1300 for providing content for hosts and loading it into a content delivery server in accordance with at least one of the various embodiments. After a start block, at block 1302, in at least one of the various embodiments, a content management application, such as, content management application 319, may determine one or more hosts that may be eligible for having content updated and/or uploaded to a content delivery server.

In at least one of the various embodiments, content may be updated periodically, or on demand as content is added or modified. For example, as new merchants are added to the system, content associated with the new merchant may need to be deployed to the content delivery server. Also, as merchants or hosts leave the system, content associated with the departing merchants and hosts may be removed from the content delivery server. In at least one of the various embodiments, users with the appropriate permissions may select hosts and/or content for updating to the content delivery servers.

At block 1304, in at least one of the various embodiments, one or more widget controllers may be generated for the one or more hosts. In at least one of the various embodiments, widget controllers may be customized for each host. Customization may include embedding policy rules, formatting, styles, or the like, into the widget controller. In at least one of the various embodiments, portions of the widget controller may common to multiple hosts leaving other portions to be customized. In at least one of the various embodiments, customization may be based on templates and may be done automatically by pulling value out of a database and placing into the widget controller based on the templates.

In at least one of the various embodiments, widget controllers may be the same for all hosts, with configuration, policy rules, or content being customized for each host.

At block 1306, in at least one of the various embodiments, widget content for the one or more hosts may be determined. In at least one of the various embodiments, widget content may include, images, video, audio files, text, CSS (e.g., styling), or the like. In at least one of the various embodiments, widget content destined for a host may be further processed (e.g., compressed, packaged, validated, or the like) to prepare it for uploading to content delivery servers.

In at least one of the various embodiments, the content management server may package the widget content to enable it to be segmented by hyper local region, content type (e.g., news, events, computer programs/scripts, images, text, videos, or the like), merchant type (e.g., florist, dentist, bakery, or the like), client type (device/application), time-of-day, or the like. In at least one of the various embodiments, within a segment, each portion of available content may be associated with an index value (e.g., an integer, string, and so on).

At block 1308, in at least one of the various embodiments, the content management application may provide the widget controller(s) and the widget content to the content delivery servers. In at least one of the various embodiments, the widget controller may provide the content to content delivery server packaged such that requests made be widget controllers operating on client application may request and receive the appropriate content.

In at least one of the various embodiments, the content management server may package the widget content to enable it to be segmented by hyper local region, content type (e.g., news, events, computer programs/scripts, images, text, videos, or the like), merchant type (e.g., florist, dentist, bakery, or the like), client type (device/application), time-of-day, or the like. In at least one of the various embodiments, within a segment, each portion of available content may be associated with an index value (e.g., an integer, string, and so on). Next, control may be returned to a calling process.

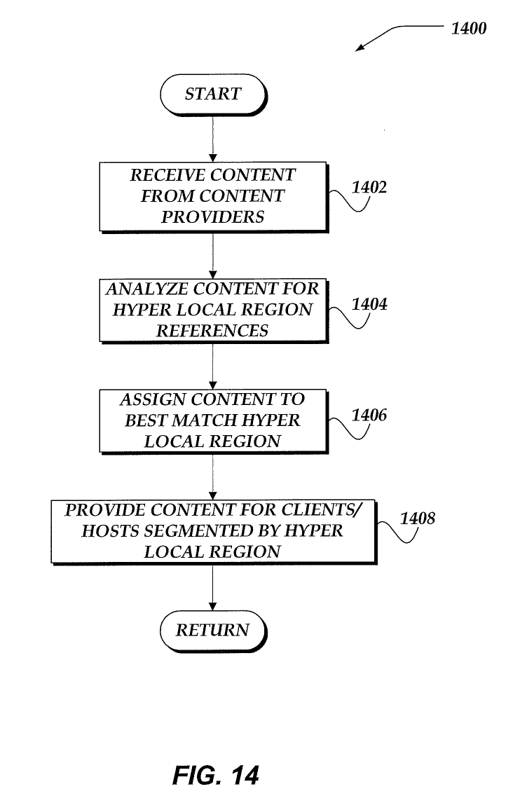

FIG. 14 is a flowchart for process 1400 for generating or processing external content for hosts and loading it into a content delivery server in accordance with at least one of the various embodiments. After a start block, at block 1402, in at least one of the various embodiments, content from one or more content providers may be provided to the content management application. In at least one of the various embodiments, this provided content may include information such as news and events. In at least one of the various embodiments, the content provider may supply a continuous stream of content, such as from a RSS feed, or the like. In at least one of the various embodiments, a content management application may be arranged to periodically retrieve (e.g., hourly, daily, weekly, or the like) content from one or more repositories.

In at least one of the various embodiments, the content management application may be arranged to provide a user-interface that enables users to enter content directly. For example, in at least one of the various embodiments, a web page may be made available to users, may enter local events that may be incorporated into the content that is uploaded to the content delivery servers.

At block 1404, in at least one of the various embodiments, the content management application may analyze the provided content to determine which hyper local region or regions the content should be associated with. In at least one of the various embodiments, the content may be scanned to identify text, sounds, or images that may be associated with one or more hyper local regions. For example, a news article including text such as “ . . . Ballard farmer's market is a big success . . . ” may be identified as being associated with the neighborhood (hyper local region) of Ballard. Likewise, image processing and machine vision may be employed to match images associated with hyper local landmarks, or the like. And, in at least one of the various embodiments, for audio content, audio processing may be used to identify spoken words or other audio artifacts that may be associated with a hyper local region. In at least one of the various embodiments, the content management server may also be arranged to scan and analyze the meta-data associated with the provided content to identify relevant hyper local region associations.

In at least one of the various embodiments, content and its meta-data may also be analyzed by the content management server to categorize and/or classify the content. Content may be classified based on the subject matter, location, target audience, age restrictions (for events), or the like.

At block 1406, in at least one of the various embodiments, which portions of provided content determined to be associated with one or more hyper local regions may be stored in a database. In at least one of the various embodiments, the database may be arranged to enable content to be indexed and/or searched based on hyper local regions, content classification values, content categorization, or the like, or combination thereof.

At block 1408, in at least one of the various embodiments, if the content has been classified, categorized, or associated with a hyper local region it may be made available for uploading to content delivery server and provided to hosts/clients. Next, in at least one of the various embodiments, control may be returned to a calling process.

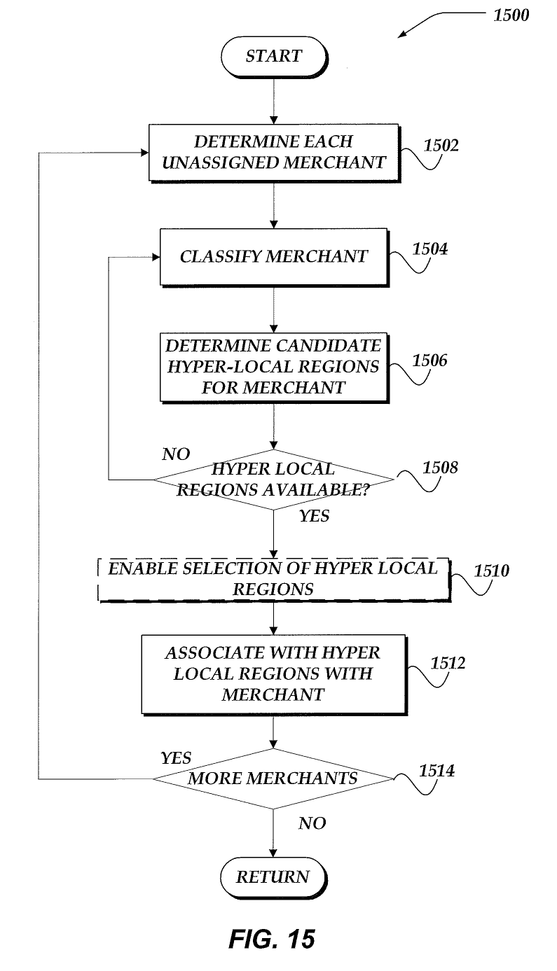

FIG. 15 is a flowchart for process 1500 for assigning merchants to hyper local regions in accordance with at least one of the various embodiments. After a start block 1502, in at least one of the various embodiments, each unassigned merchant may be determined by the content management application.

At block 1504, in at least one of the various embodiments, the merchant may be classified into to or categories or types. In at least one of the various embodiments, merchants may be classified based on the kinds of service and/or products they offer. In at least one of the various embodiments, in some cases, a merchant may qualify to be assigned to multiple categories. In at least one of the various embodiments, merchant categories may include florist, bakery, dry cleaner, dentist, oral surgery, restaurant, coffee shop, or the like.

At block 1506, in at least one of the various embodiments, one or more hyper local regions that may be initially eligible may be determined. In at least one of the various embodiments, the address of the merchant locations may be used to determine one or more candidate hyper local regions to associate with the merchant. In at least one of the various embodiments, the address of the merchant may be converted into a geographic coordinates (such as GPS coordinates) and for mapping to hyper local regions.

At decision block 1508, in at least one of the various embodiments, if there are hyper local regions determined to be available to assign the merchant, control may flow to block 1510; otherwise, control may loop back to block 1504. In at least one of the various embodiments, policy rules may be in place that a limit the number and/or category of merchant that may be associated with a hyper local regions. In at least one of the various embodiments, a hyper local region may be restricted such that the number of merchants of a given category associated with a particular hyper local region may not exceed a defined threshold.

In at least one of the various embodiments, in some cases merchants may be eligible to be associated with multiple hyper local regions. For example, a merchant may be interested in presenting content to consumers located in two or more adjacent hyper local regions. Similarly, a merchant may have locations in two or more hyper local regions and would like content to be presented to consumers in each hyper local region. In at least one of the various embodiments, different categories of merchants (e.g. roofers) may support a much broader area of business area while other categories (e.g. dry cleaners) may have a much smaller service area. Accordingly, in at least one of the various embodiments, merchants in categories known to be associated with larger business areas may be associated with more and/or larger hyper local regions than merchants in categories known to have smaller business areas.

At block 1510, in at least one of the various embodiments, optionally, a user-interface may be provided to enable a user to confirm if the hyper local regions are appropriate. Also, in at least one of the various embodiments, a user may override the hyper local regions that were determined by the content management application.

At block 1512, in at least one of the various embodiments, the merchant may be associated with the one or more hyper local regions that may have been determined in block 1506, or in block 1510. At decision block 1514, in at least one of the various embodiments, if more merchants remain to be classified, control may loop back block 1502; otherwise, control may be returned to a calling process.

### Illustrative Use Cases

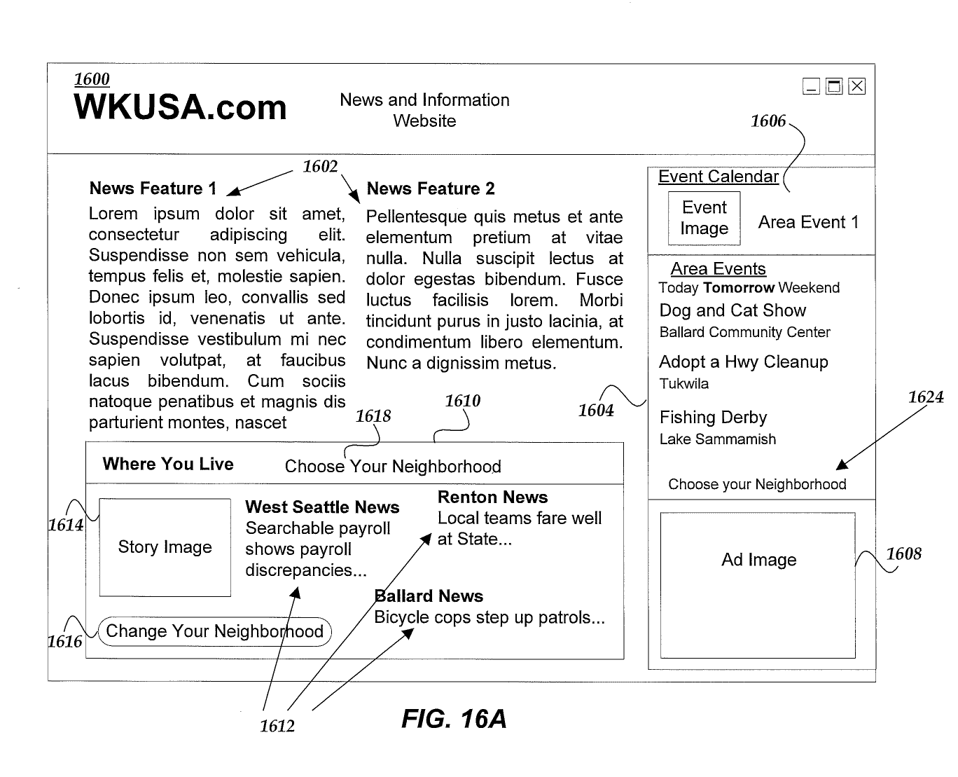

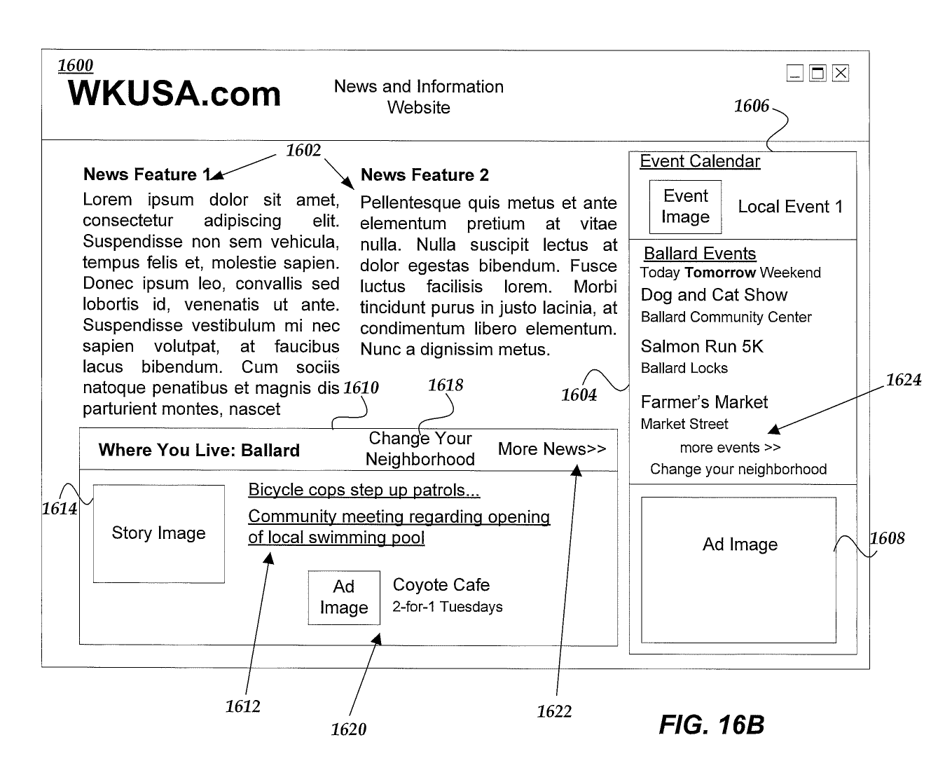

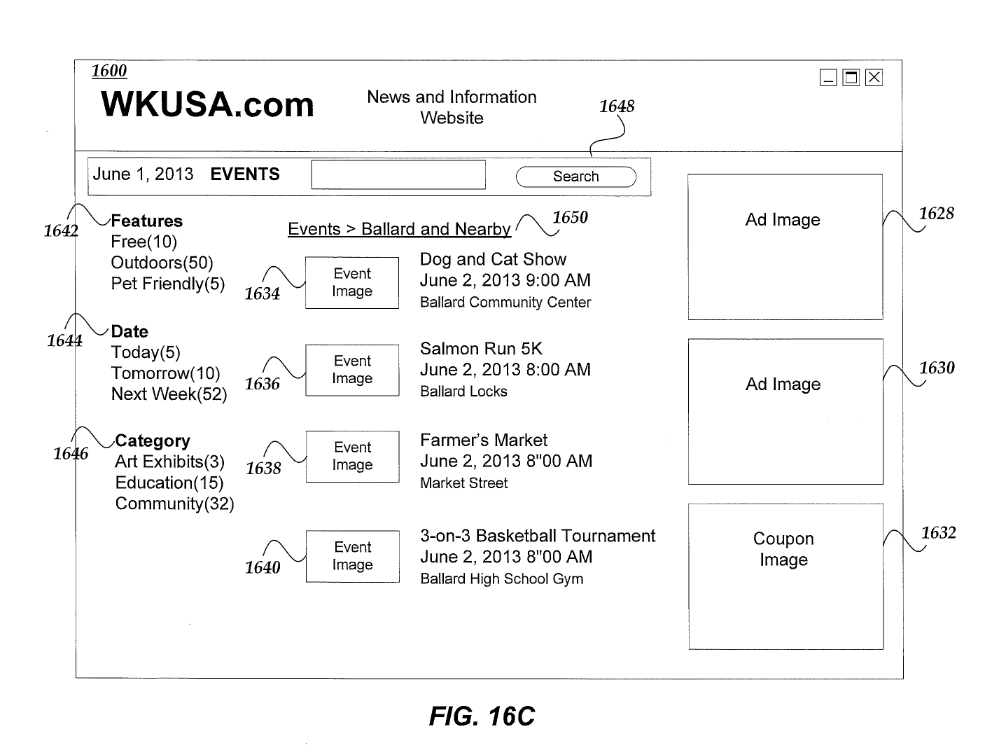

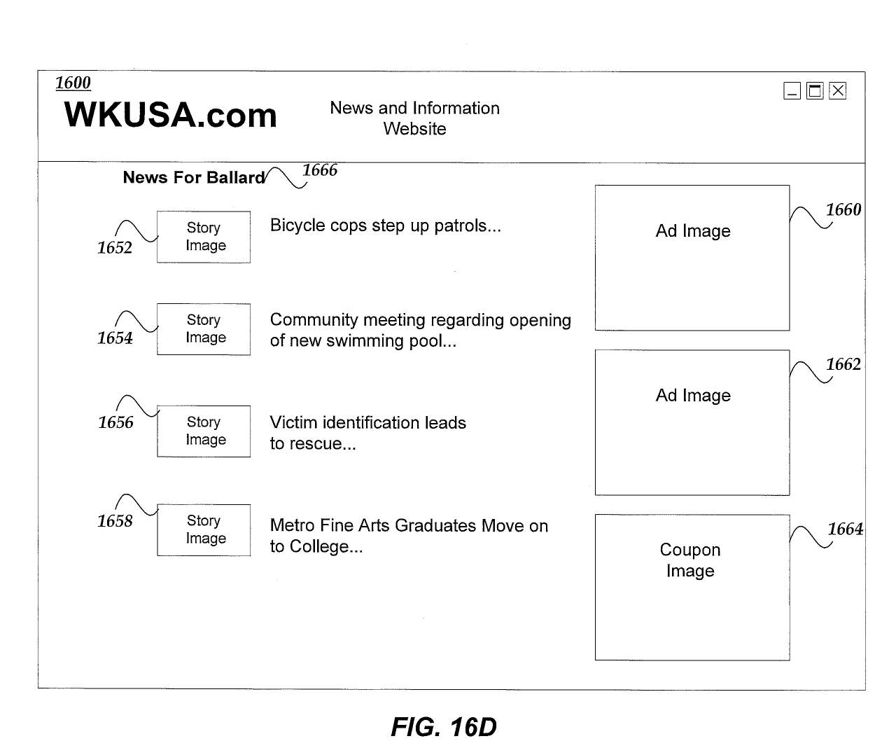

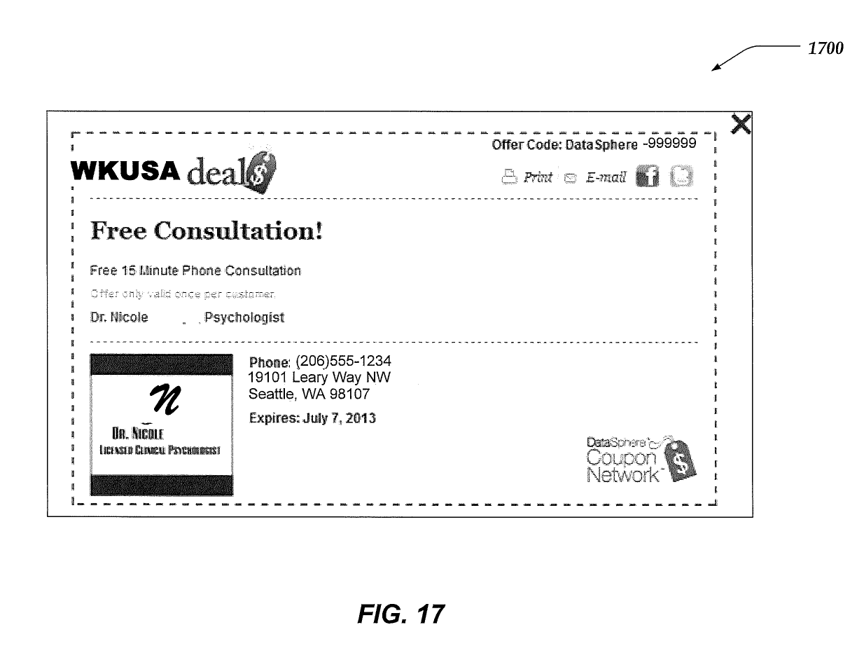

FIGS. 16A-16D and 17 represent use cases for hyper local targeting based on user location in accordance with at least one of the various embodiments. In at least one of the various embodiments, user interfaces other than user interface 1600 and 1700 may be employed without departing from the spirit and/or scope of the claimed subject matter. Such user interfaces may have more or fewer user interface elements which may be arranged in various ways. In some embodiments, user interfaces may be generated using web pages, mobile applications, or the like. In at least one of the various embodiments, widget controller 210, widgets 212, content management application 319, and content delivery application 320 may include processes and/or API's for generating user interfaces, such as user interfaces 1600 and 1700.

FIG. 16A shows user-interface 1600 for hyper local targeting based on user location in accordance with at least one of the various embodiments. FIG. 16A shows the interface as it may be displayed before a consumer location has been determined (either by inference or selection). This example embodiment may represent a web page for a fictitious television or radio news station having the call sign of WKUSA. One or more news features, such as news features 1602 may be displayed. These news features represent news content that may be provided by the host server rather than being managed by a content management application of provided from a content delivery server.

Widget 1604 may be an event widget showing a selection of upcoming events for the entire metropolitan area. In this example, three events from three different neighborhoods (e.g., hyper local regions) are displayed in widget 1604. Since, the neighborhood for the consumer has not been determined the events are from three different neighborhoods in the greater Seattle metropolitan area including, Ballard, Tukwila, and Lake Sammamish

In at least one of the various embodiments, another strategy for presenting events to users who have not selected a neighborhood may be to show the most popular or the most recent events for the broader area or region, or the events that may be the closest to the consumer based on a consumer's current location. In some embodiments, the consumer's current location may determined based on a mobile device's current GPS location.

Widget 1604 may be arranged into various configuration, in one example, the top portion of the widget may display featured event 1606 and the bottom portion may display advertisement image 1608. Again, since, the neighborhood for the consumer has not been determined advertisement 1608 may be representing a merchant that may be assignment to anywhere in the greater Seattle metropolitan area.

Widget 1610 may be arranged to show hyper local news, such as, neighborhood news. In this example, three news stories from three different hyper local regions (e.g., neighborhoods) are displayed in widget 1610. Since, the hyper local region for the consumer has not been determined the news stories are displayed regarding from three different hyper local regions (neighborhoods) in the greater Seattle metropolitan area including, West Seattle, Renton, and Ballard. Story Image 1614 may be showing a thumbnail image for a highlighted news story. Or, in at least one of the various embodiments, it may cycle through thumbnail images for each story (e.g., slideshow action). Button 1616 and link 1618 may be arranged to enable a consumer to choose a hyper local region (neighborhood). In at least one of the various embodiments, if a consumer presses button 1616 or clicking on line 1618 may cause the widget controller running on the client to display a user interface similar to user-interface 600 of FIG. 6 for selecting a hyper local region.

Furthermore, in at least one of the various embodiments, event widget 1604 may include links 1624 may be arranged to enable a consumer to select a hyper local region, similar to link 1618.

FIG. 16B shows user-interface 1600 for hyper local targeting based on user location in accordance with at least one of the various embodiments. FIG. 16B shows the interface as it may be displayed after a consumer location has been determined (either by inference or selection) to be Ballard, a hyper local region of Seattle, Wash. In at least one of the various embodiments, news features 1602 provided buy the host (WKUSA.com) may remain unchanged but widgets 1604 and 1610 may be update by the widget controller to reflect that the hyper local region for the consumer viewing the page has been determined. In some embodiments, the events in widget 1604 may be from the neighborhood selected by the consumer thus they are all events that are occurring in the Ballard neighborhood. Likewise, featured event 1606 may be configured to show an event from the Ballard neighborhood. And, advertisement 1608 may be configured to show an advertisement for a merchant that is associated with the Ballard neighborhood. Links 1624 has also been modified to include an option to display more events. If the consumer selects “more events” the user-interface may be modified to show additional events from the determined hyper local region. (See, FIG. 16C.)

Also, widget 1610 remains displayed on user-interface 1600, though it has been modified such that stories 1612 and story image 1614 are now each related to the Ballard neighborhood (e.g. the consumers selected hyper local region). Link 1618 is now updated to show that the hyper local region may be changed by the consumer. And link 1622 enables a consumer to view more news stories associated with their determined hyper local region. (See, FIG. 16D.)

FIG. 16C shows user-interface 1600 for hyper local targeting based on user location in accordance with at least one of the various embodiments. FIG. 16C shows an interface for viewing additional events that may be relevant to a consumer based on their determined hyper local region. An events page may include content such as advertising images 1628 and 1630 and coupon image 1632. These images may show advertisement text and/or images related to a merchant that may be assignment to the hyper local regions associated with the consumer. For example, in this case, the hyper local region is “Ballard and Nearby” as shown by label 1650. Events 1634, 1636 1638 and 1640 show images, title, description, date/time, locations of the event. In some embodiments, a consumer may click on the event to bring up a detail page, or send the consumer to a web page provided by the event holder, or the like.

In at least one of the various embodiments, various options for filtering and sorting the events may be presented to consumer. Filter 1642 enables a consumer to filter events based on one or characteristics of the event. Filter 1642, in this example, enables events to the filtered based on whether the event is free to attend (Free), occurs outdoors (Outdoors), or is pet friendly. Similarly, filter Data 1644 enables filtering of events based on how far in the future they occur; and filter 1646 enables filtering of events based on category, such as, Art Exhibit, Education, Community, Food and Drink, Fairs and Festivals, or the like. Clearly, one of ordinary skill in the art will appreciate that more or less filters for events may be displayed and/or made active depending on the available events and/or how the content management application has been configured. Search bar 1648 may be a user-interface component the enables consumer to enter search terms if searching for events that they may be interested in.

FIG. 16D shows user-interface 1600 for hyper local targeting based on user location in accordance with at least one of the various embodiments. FIG. 16D shows the interface as it may be displayed for viewing news content that may be relevant to a consumer based on a determined hyper local region. In at least one of the various embodiments, news stories 1652, 1654, 1656, 1658, may include one or more images, a story summary, or the like, for a news story. In at least one of the various embodiments, a consumer may select one or more of the stories see additional details. In at least one of the various embodiments, the hyper local region associated with the displayed news stories may be indicated in various ways, include as shown by label 1666, indicating that the news is for the Ballard neighborhood of Seattle, Wash. Similar to the events page (FIG. 16C), content associated with merchants such as, advertisement image 1660, 1662, and coupon image 1664 may be displayed for merchants associated with the hyper local region (e.g., Ballard). Furthermore, in at least one of the various embodiments, filters and search tools similar to those shown in FIG. 16C may be displayed as well.

FIG. 17 shows user-interface 1700 for displaying content that may be illustrative of a coupon for a merchant in accordance with at least one of the various embodiments. As discussed above, coupons may be a specialized for a advertisement content that consumer may access from one or more locations. In at least one of the various embodiments, coupon 1700 may be arranged to shows information related the merchant that may be associated with the coupons. In some cases, a displayed coupon may be a widget that is provided content by its corresponding widget controller.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer-implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the flowchart illustration may also be performed concurrently with other blocks or combinations of blocks, or even in a different sequence than illustrated without departing from the scope or spirit of the invention.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems, which perform the specified actions or steps, or combinations of special purpose hardware and computer instructions. The foregoing example should not be construed as limiting and/or exhaustive, but rather, an illustrative use case to show an implementation of at least one of the various embodiments of the invention.

1. A method for managing content over a network, wherein at least one network device performs actions, comprising:
providing a widget controller to a client device, wherein the widget controller enables further actions to be performed, including:
determining a location that is associated with a consumer, wherein the location is included in a profile of the consumer;
enabling the consumer to identify at least one hyper-local region that corresponds to the location, wherein the consumer's profile is updated with the at least one identified hyper-local region;
generating a request for content to at least one content delivery resource based the consumer's updated profile;
providing content to the client device from the at least one content delivery resource that corresponds to the request;
deploying the provided content to at least one widget based on at least a type of content;
monitoring one or more actions by the consumer with the at least one widget, wherein the one or more monitored action includes clicking on content, viewing content, or redeeming a coupon, wherein redeeming the coupon is weighted higher than viewing content based on its relevance to at least one hyper-local region, and wherein the monitored actions are communicated to a content management server device; and
employing the at least one weighted monitored action to associate the at least one hyper-local region with the consumer, wherein the consumer's profile is updated to include both the identified hyper-local region and the at least one hyper-local region associated with the consumer, and wherein a subsequent request for content is generated based on the updated consumer's profile.

2. The method of claim 1, determining a location that is associated the consumer further comprises:
if a number of visits to the client device by the consumer exceeds a threshold, performing further actions, comprising:
prompting the consumer to select the at least one hyper-local region; and
updating the consumer's profile to include the selected hyper-local region.

3. The method of claim 1, further comprising:
enabling the content manager device to perform actions, including:
generating a plurality of metrics based on the monitored one or more consumer actions;
determining the at least one hyper-local region that is associated with consumer based on at least a portion of the plurality of metrics; and
updating the consumer profile to include the determined at least one hyper-local region until the consumer identifies the at least one hyper-local region.

4. The method of claim 1, further comprising:
registering at least one event with the client device, wherein the at least one event is associated with the widget controller;
suspending operation of the widget controller, wherein the client device is enabled to process other content during the suspension of the widget controller; and
restoring operation of the widget controller when the at least one event occurs.

5. The method of claim 1, further comprising:
determining a display location for the at least one widget on a user interface for the client device; and
modifying at least one geometric attribute of the at least one widget to fit the display location when the display location is unable to fit the at least one widget.

6. The method of claim 1, further comprising, if two or more widgets enable a display of the provided content that is similar, rotating the provided content that is displayable at the same time by the two or more widgets.

7. The method of claim 1, wherein providing content to the client device, further comprises, providing content that includes at least one of an advertisement, a coupon, a news story, or an event story that is associated with the at least one identified hyper-local region.

8. The method of claim 1, further comprising:
classifying at least one merchant based on an offering associated with the at least one merchant;
determining at least one candidate hyper-local region based on a geographic location that is associated with the at least one merchant; and
if a number of other merchants having the same classification as the at least one merchant is less than a threshold value, associating the at least one merchant with the candidate hyper-local region.

9. A system for managing content over a network, comprising:
a network device, including:
a transceiver for communicating over the network;
a memory for storing at least instructions;
a processor device that is operative to execute instructions that enable actions, including:
providing a widget controller to a client device, wherein the widget controller enables further actions to be performed, including:
determining a location that is associated with a consumer, wherein the location is included in a profile of the consumer;
enabling the consumer to identify at least one hyper-local region that corresponds to the location, wherein the consumer's profile is updated with the at least one identified hyper-local region;
generating a request for content to at least one content delivery resource based the consumer's updated profile;
providing content to the client device from the at least one content delivery resource that corresponds to the request;
deploying the provided content to at least one widget based on at least a type of content;
monitoring one or more actions by the consumer with the at least one widget, wherein the one or more monitored action includes clicking on content, viewing content, or redeeming a coupon, wherein redeeming the coupon is weighted higher than viewing content based on its relevance to at least one hyper-local region, and wherein the monitored actions are communicated to a content management server device; and
employing the at least one weighted monitored action to associate the at least one hyper-local region with the consumer, wherein the consumer's profile is updated to include both the identified hyper-local region and the at least one hyper-local region associated with the consumer, and wherein a subsequent request for content is generated based on the updated consumer's profile; and
a client network device, including:
a transceiver for communicating over the network;
a memory for storing at least instructions;
a processor device that is operative to execute instructions that enable actions, including:
receiving the widget controller; and
receiving content from the at least one content delivery resource that corresponds to the request.

10. The system of claim 9, determining a location that is associated the consumer further comprises:
if a number of visits to the client device by the consumer exceeds a threshold, performing further actions, comprising:
prompting the consumer to select the at least one hyper-local region; and
updating the consumer's profile to include the selected hyper-local region.

11. The system of claim 9, further comprising:
enabling the content manager device to perform actions, including:
generating a plurality of metrics based on the monitored one or more consumer actions;
determining the at least one hyper-local region that is associated with consumer based on at least a portion of the plurality of metrics; and
updating the consumer profile to include the determined at least one hyper-local region until the consumer identifies the at least one hyper-local region.

12. The system of claim 9, further comprising:
registering at least one event with the client device, wherein the at least one event is associated with the widget controller;
suspending operation of the widget controller, wherein the client device is enabled to process other content during the suspension of the widget controller; and
restoring operation of the widget controller when the at least one event occurs.

13. The system of claim 9, further comprising:
determining a display location for the at least one widget on a user interface for the client device; and
modifying at least one geometric attribute of the at least one widget to fit the display location when the display location is unable to fit the at least one widget.

14. The system of claim 9, further comprising, if two or more widgets enable a display of the provided content that is similar, rotating the provided content that is displayable at the same time by the two or more widgets.

15. The system of claim 9, wherein providing content to the client device, further comprises, providing content that includes at least one of an advertisement, a coupon, a news story, or an event story that is associated with the at least one identified hyper-local region.

16. The system of claim 9, further comprising:
classifying at least one merchant based on an offering associated with the at least one merchant;
determining at least one candidate hyper-local region based on a geographic location that is associated with the at least one merchant; and
if a number of other merchants having the same classification as the at least one merchant is less than a threshold value, associating the at least one merchant with the candidate hyper-local region.

17. A processor readable non-transitory storage media that includes instructions for managing content over a network, wherein a network device that executes at least a portion of the instructions enables actions, comprising:
providing a widget controller to a client device, wherein the widget controller enables further actions to be performed, including:
determining a location that is associated with a consumer, wherein the location is included in a profile of the consumer;
enabling the consumer to identify at least one hyper-local region that corresponds to the location, wherein the consumer's profile is updated with the at least one identified hyper-local region;
generating a request for content to at least one content delivery resource based the consumer's updated profile;
providing content to the client device from the at least one content delivery resource that corresponds to the request;
deploying the provided content to at least one widget based on at least a type of content;
monitoring one or more actions by the consumer with the at least one widget, wherein the one or more monitored action includes clicking on content, viewing content, or redeeming a coupon, wherein redeeming the coupon is weighted higher than viewing content based on its relevance to at least one hyper-local region, and wherein the monitored actions are communicated to a content management server device; and
employing the at least one weighted monitored action to associate the at least one hyper-local region with the consumer, wherein the consumer's profile is updated to include both the identified hyper-local region and the at least one hyper-local region associated with the consumer, and wherein a subsequent request for content is generated based on the updated consumer's profile.

18. The media of claim 17, determining a location that is associated the consumer further comprises:
if a number of visits to the client device by the consumer exceeds a threshold, performing further actions, comprising:
prompting the consumer to select the at least one hyper-local region; and
updating the consumer's profile to include the selected hyper-local region.

19. The media of claim 17, further comprising:
enabling the content manager device to perform actions, including:
generating a plurality of metrics based on the monitored one or more consumer actions;
determining the at least one hyper-local region that is associated with consumer based on at least a portion of the plurality of metrics; and
updating the consumer profile to include the determined at least one hyper-local region until the consumer identifies the at least one hyper-local region.

20. The media of claim 17, further comprising:
registering at least one event with the client device, wherein the at least one event is associated with the widget controller;
suspending operation of the widget controller, wherein the client device is enabled to process other content during the suspension of the widget controller; and
restoring operation of the widget controller when the at least one event occurs.

21. The media of claim 17, further comprising:
determining a display location for the at least one widget on a user interface for the client device; and
modifying at least one geometric attribute of the at least one widget to fit the display location when the display location is unable to fit the at least one widget.

22. The media of claim 17, wherein providing content to the client device, further comprises, providing content that includes at least one of an advertisement, a coupon, a news story, or an event story that is associated with the at least one identified hyper-local region.

23. The media of claim 17, further comprising:
classifying at least one merchant based on an offering associated with the at least one merchant;
determining at least one candidate hyper-local region based on a geographic location that is associated with the at least one merchant; and
if a number of other merchants having the same classification as the at least one merchant is less than a threshold value, associating the at least one merchant with the candidate hyper-local region.

24. A network device for managing content over a network, comprising:
a transceiver for communicating over the network;
a memory for storing at least instructions;
a processor device that is operative to execute instructions that enable actions, including:
providing a widget controller to a client device, wherein the widget controller enables further actions to be performed, including:
determining a location that is associated with a consumer, wherein the location is included in a profile of the consumer;
enabling the consumer to identify at least one hyper-local region that corresponds to the location, wherein the consumer's profile is updated with the at least one identified hyper-local region;
generating a request for content to at least one content delivery resource based the consumer's updated profile;
providing content to the client device from the at least one content delivery resource that corresponds to the request;
deploying the provided content to at least one widget based on at least a type of content;
monitoring one or more actions by the consumer with the at least one widget, wherein the one or more monitored action includes clicking on content, viewing content, or redeeming a coupon, wherein redeeming the coupon is weighted higher than viewing content based on its relevance to at least one hyper-local region, and wherein the monitored actions are communicated to a content management server device; and
employing the at least one weighted monitored action to associate the at least one hyper-local region with the consumer, wherein the consumer's profile is updated to include both the identified hyper-local region and the at least one hyper-local region associated with the consumer, and wherein a subsequent request for content is generated based on the updated consumer's profile.

25. The network device of claim 24, determining a location that is associated the consumer further comprises:
if a number of visits to the client device by the consumer exceeds a threshold, performing further actions, comprising:
prompting the consumer to select the at least one hyper-local region; and
updating the consumer's profile to include the selected hyper-local region.

26. The network device of claim 24, further comprising:
enabling the content manager device to perform actions, including:
generating a plurality of metrics based on the monitored one or more consumer actions;
determining the at least one hyper-local region that is associated with consumer based on at least a portion of the plurality of metrics; and
updating the consumer profile to include the determined at least one hyper-local region until the consumer identifies the at least one hyper-local region.

27. The network device of claim 24, further comprising:
registering at least one event with the client device, wherein the at least one event is associated with the widget controller;
suspending operation of the widget controller, wherein the client device is enabled to process other content during the suspension of the widget controller; and
restoring operation of the widget controller when the at least one event occurs.

28. The network device of claim 24, further comprising:
determining a display location for the at least one widget on a user interface for the client device; and
modifying at least one geometric attribute of the at least one widget to fit the display location when the display location is unable to fit the at least one widget.

29. The network device of claim 24, wherein providing content to the client device, further comprises, providing content that includes at least one of an advertisement, a coupon, a news story, or an event story that is associated with the at least one identified hyper-local region.

30. The network device of claim 24, further comprising:
classifying at least one merchant based on an offering associated with the at least one merchant;
determining at least one candidate hyper-local region based on a geographic location that is associated with the at least one merchant; and
if a number of other merchants having the same classification as the at least one merchant is less than a threshold value, associating the at least one merchant with the candidate hyper local region.
